(19) United States
(12) Patent Application Publication
(10) Pub. No.: US 2013/0212209 A1
(43) Pub. Date: Aug. 15, 2013

(54) INFORMATION PROCESSING APPARATUS, SWITCH, STORAGE SYSTEM, AND STORAGE SYSTEM CONTROL METHOD

(71) Applicant: FUJITSU LIMITED, (US)

(72) Inventor: Keiji Miyauchi, Yokohama (JP)

(73) Assignee: FUJITSU LIMITED, Kawasaki-shi (JP)

(21) Appl. No.: 13/852,424

(22) Filed: Mar. 28, 2013

Related U.S. Application Data
(63) Continuation of application No. PCT/JP2010/067375, filed on Oct. 4, 2010.

(51) Int. Cl. H04L 29/08

(52) U.S. Cl. CPC H04L 29/08549
USPC 709/213

(57) ABSTRACT

In an information processing apparatus, a data controller performs transmission and reception of data with a storage apparatus having a storage region allocated to the information processing apparatus by a physical port or a virtual port set at the physical port. The physical port transmits and receives data by communicating with the storage apparatus. A management controller calculates a use rate based on a storage capacity of the allocated storage region of the storage apparatus and an amount of use of the storage region and determines whether to perform allocation based on the calculated use rate. When determining to perform the allocation, the management controller allocates an unallocated storage region allocated to none of information processing apparatuses to the information processing apparatus, and also sets a virtual port and connects the information processing apparatus to the allocated storage region by the virtual port.

### CROSS-REFERENCE TO RELATED APPLICATION

This application is a continuation application of International Application PCT/JP2010/067375 filed on Oct. 4, 2010 which designated the U.S., the entire contents of which are incorporated herein by reference.

### FIELD

The embodiments discussed herein relate to an information processing apparatus, a switch, a storage system, and a storage system control method.

### BACKGROUND

A SAN (Storage Area Network) is widely used hitherto, in which storage apparatuses are connected to each other or a storage apparatus and a computer are connected by a communication network, such as a fibre channel and a LAN (Local Area Network), thereby enabling high-speed data communication. Due to this, it is possible to construct a storage system that provides a large-capacity storage region for a server while reducing an increase in load of the server and communication network and an increase in management processing.

The following techniques relating to a system in which a storage apparatus and a computer are connected by a communication network are known.
Japanese Laid-open Patent Publication No. 2003-296037
Japanese Laid-open Patent Publication No. 2009-146106

Here, on a server that uses the SAN, access restrictions by zoning setting are imposed in order to maintain consistency of data with another server and confidentiality. Because of this, it is not possible for a server that uses the SAN to freely receive allocation of storage capacity from a storage apparatus connected to another server even when the allocated storage capacity of the storage apparatus runs short. Consequently, in order to increase the storage capacity allocated to the server, there is such a problem that it is necessary to receive allocation of a storage region from the storage apparatus used by the other server by once suspending communication between the server and the storage apparatus connected to a switch and changing the zoning setting, or to provide a new storage apparatus and allocate a storage region prepared for the server, or to increase the number of resources by performing settings of the server and storage.

### SUMMARY

According to an aspect, there is provided an information processing apparatus of a storage system in which a plurality of information processing apparatuses reads and writes data from and to storage regions of a plurality of storage apparatuses connected by a communication line via a switch. The information processing apparatus has a physical port configured to transmit and receive the data by communicating with the storage apparatus and a processor configured to perform a procedure including: calculating, based on a storage capacity of a storage region of a storage apparatus allocated to the information processing apparatus and an amount of use of the storage region, a use rate of the storage region; determining whether or not to perform allocation of a storage region based on the calculated use rate; allocating, when determining to perform the allocation of a storage region, an unallocated storage region allocated to none of information processing apparatuses to the information processing apparatus, and also setting a virtual port and making connection with the unallocated storage region allocated to the information processing apparatus by the set virtual port; and performing transmission and reception of data with a storage apparatus having the storage region allocated to the information processing apparatus by the physical port or the virtual port set at the physical port.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates a storage system including an information processing apparatus, a switch, and a storage apparatus of a first embodiment;

FIG. 2 illustrates a system configuration of a second embodiment;

FIG. 3 illustrates a hardware configuration of a server of the second embodiment;

FIG. 4 illustrates a hardware configuration of a fibre channel switch of the second embodiment;

FIG. 5 is a block diagram illustrating functions of the server of the second embodiment;

FIG. 6 illustrates a control table of the second embodiment;

FIG. 7 illustrates connections between servers and storage regions of storage apparatuses based on zones of the second embodiment;

FIG. 8 illustrates connections between servers and storage regions of storage apparatuses based on zones of the second embodiment;

FIG. 9 is a flowchart illustrating a procedure of allocation storage region management processing of the second embodiment;

FIG. 10 is the flowchart illustrating the procedure of allocation storage region management processing of the second embodiment;

FIG. 11 is a flowchart illustrating a procedure of storage region disconnection processing of the second embodiment;

FIG. 12 is the flowchart illustrating the procedure of storage region disconnection processing of the second embodiment;

FIG. 13 is the flowchart illustrating the procedure of storage region disconnection processing of the second embodiment;

FIG. 14 is a flowchart illustrating a procedure of storage region allocation processing of the second embodiment;

FIG. 15 is the flowchart illustrating the procedure of storage region allocation processing of the second embodiment;

FIG. 16 is the flowchart illustrating the procedure of storage region allocation processing of the second embodiment;

FIG. 17 is a sequence diagram illustrating a procedure of processing at the time of determination of disconnection of an empty region and allocation of an unallocated storage region performed in a storage system of the second embodiment;

FIG. 18 is a sequence diagram illustrating a procedure of processing at the time of disconnection of an empty region performed in the storage system of the second embodiment;

FIG. 19 is the sequence diagram illustrating the procedure of processing at the time of disconnection of an empty region performed in the storage system of the second embodiment;

FIG. 20 is a sequence diagram illustrating a procedure of processing at the time of allocation of an unallocated storage region performed in the storage system of the second embodiment;

FIG. 21 is the sequence diagram illustrating the procedure of processing at the time of allocation of an unallocated storage region performed in the storage system of the second embodiment;

FIG. 22 illustrates connections between servers and storage regions of storage apparatuses by physical ports and virtual ports of a third embodiment;

FIG. 23 illustrates connections between servers and storage regions of storage apparatuses by physical ports and virtual ports of a fourth embodiment; and

FIG. 24 illustrates connections between servers and storage regions of storage apparatuses by physical ports and virtual ports of a fifth embodiment.

### DESCRIPTION OF EMBODIMENTS

Several embodiments will be described below with reference to the accompanying drawings, wherein like reference numerals refer to like elements throughout.

### First Embodiment

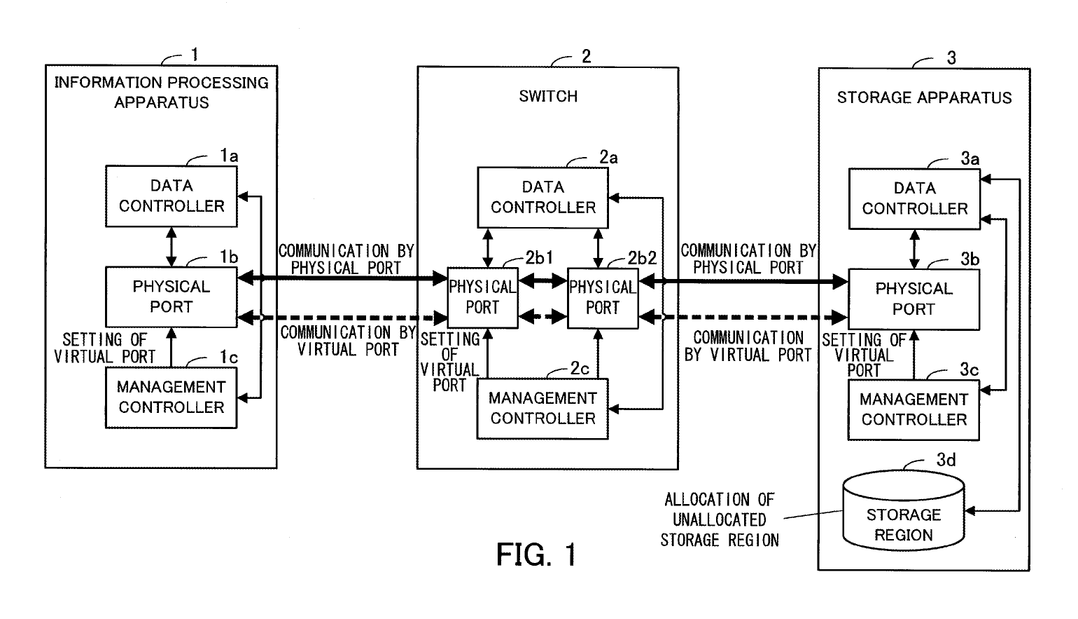

FIG. 1 illustrates a storage system including an information processing apparatus, a switch, and a storage apparatus of a first embodiment. In the storage system of the present embodiment, a plurality of information processing apparatuses reads and writes data from and to storage regions of a plurality of storage apparatuses connected by an electric or optical communication line via a switch 2. An information processing apparatus 1 of the present embodiment has a data controller 1a, a physical port 1b, and a management controller 1c. The switch 2 has a data controller 2a, physical ports 2b1 and 2b2, and a management controller 2c. A storage apparatus 3 has a data controller 3a, a physical port 3b, a management controller 3c, and a storage region 3d.

The data controller 1a of the information processing apparatus 1 performs transmission and reception of data with the storage apparatus 3 having a storage region allocated to the information processing apparatus 1 by the physical port 1b or a virtual port set at the physical port 1b.

The physical port 1b is connected to the physical port 2b1 by an electric or optical communication line and transmits and receives data by communicating with the storage apparatus 3. At the physical port 1b, a virtual port configured to transmit and receive data by communicating with the storage apparatus 3 via the switch 2 is set by the management controller 1c. The physical port 1b and the virtual port set at the physical port 1b perform individual communications logically independent of each other. Data communicated by the physical port 1b is not transmitted or received at the connection destination of the virtual port (for example, unallocated storage region of the storage apparatus 3 allocated to the information processing apparatus 1) set by a virtual port to be set. Further, data communicated by a virtual port to be set is not transmitted or received at the connection destination of the physical port 2b1 (for example, storage region of another storage apparatus (not illustrated) or storage region other than the unallocated storage region of the storage apparatus 3 allocated to the information processing apparatus 1). This also applies to the following physical ports 2b1, 2b2, and 3b and the virtual ports to be set thereat, respectively.

The management controller 1c calculates a use rate based on the storage capacity of the allocated storage region of the storage apparatus 3 and the amount of use of the storage region and determines whether or not to perform allocation based on the calculated use rate.

When determining to perform allocation, the management controller 1c allocates an unallocated storage region allocated to none of the information processing apparatuses 1 to the information processing apparatus 1, and also sets a virtual port at the physical port 1b and connects the information processing apparatuses 1 to the unallocated storage region allocated by the set virtual port. The set virtual port is set so as to exclusively connect the information processing apparatus 1 and the unallocated storage region. That is, it is not possible for another information processing apparatus (not illustrated) or another storage apparatus of the storage system to access the set virtual port or the unallocated storage region allocated to the information processing apparatus 1.

The data controller 2a of the switch 2 performs transmission and reception of data with the storage apparatus 3 having the storage region allocated to the information processing apparatus 1 by the physical port 2b1 or a virtual port set at the physical port 2b1, and also performs transmission and reception of data with the storage apparatus 3 by the physical port 2b or a virtual port set at the physical port 2b2.

The physical port 2b1 is connected to the physical port 1b by an electric or optical communication line and transmits and receives data by communicating with the information processing apparatus 1. At the physical port 2b1, a virtual port configured to transmit and receive data by communicating with the information processing apparatus 1 is set by the management controller 2c. The physical port 2b2 is connected to the physical port 3b by an electric or optical communication line and transmits and receives data by communicating with the storage apparatus 3. At the physical port 2b2, a virtual port configured to transmit and receive data by communicating with the storage apparatus 3 is set by the management controller 2c. The switch 2 relays transmission and reception of data between apparatuses of the storage system, such as the information processing apparatus 1 and the storage apparatus 3, by the physical ports 2b1 and 2b2, the virtual ports set thereat, respectively, and other physical ports and virtual ports, not illustrated.

When a request is made from the information processing apparatus 1 for connection of an unallocated storage region, the management controller 2c connects the information processing apparatus 1 having made the request and the unallocated storage region by the virtual port set at the physical port 2b1 and the virtual port set at the physical port 2b2.

The data controller 3a of the storage apparatus 3 performs transmission and reception of data with the information processing apparatus 1 by the physical port 3b or a virtual port set at the physical port 3b.

The physical port 3b is connected to the physical port 2b2 by an electric or optical communication line and transmits and receives data by communicating with the information processing apparatus 1. At the physical port 3b, the virtual port configured to transmit and receive data by communicating with the information processing apparatus 1 is set by the management controller 3c.

When a request is made from the information processing apparatus 1 for allocation of an unallocated storage region, the management controller 3c sets a virtual port and connects the unallocated storage region whose allocation has been requested and the information processing apparatus 1 having made the request by the virtual port.

The storage region 3d is a storage region from or to which data may be read or written by control of the data controller 3a. It is possible to configure the storage region 3d as a storage region of a magnetic storage apparatus, an optical disc, a magneto-optical storage medium, a semiconductor memory, and another storage apparatus from or to which data may be read or written. The magnetic storage apparatus includes a hard disk drive (HDD), a flexible disc (FD), a magnetic tape, etc. The optical disk includes a DVD (Digital Versatile Disc), a DVD-RAM (Random Access Memory), a CD-ROM (Compact Disc Read Only Memory), a CD-R (Recordable)/RW (ReWritable), etc. The magneto-optical storage medium includes an MO (Magneto-Optical disk) etc. The semiconductor memory includes a RAM, which is a volatile semiconductor memory, a writable nonvolatile semiconductor memory etc., such as a Flash SSD (Solid State Drive). The storage region 3d may be a RAID (Redundant Arrays of Inexpensive Disks) having a plurality of storages or a JBOD (Just a Bunch Of Disks).

As described above, in the information processing apparatus 1, the management controller 1c calculates the use rate based on the storage capacity of the allocated storage region of the storage apparatus 3 and the amount of use of the storage region and determines whether or not to perform allocation based on the calculated use rate. When determining to perform allocation, the management controller 1c allocates an unallocated storage region of the storage region 3d of the storage apparatus 3 to the information processing apparatus 1, and also sets a virtual port at the physical port 1b and connects the information processing apparatuses 1 to the unallocated storage region of the storage apparatus 3 allocated by the set virtual port. Due to this, when the storage capacity allocated to the information processing apparatus 1 runs short, it is made possible to easily change arrangement of storage resources of each apparatus of the storage system without the need to newly provide a storage apparatus or the need to stop the communication operation of each apparatus of the storage system.

### Second Embodiment

Next, an embodiment in which the function to change arrangement of storage regions of a storage system of the information processing apparatus 1 illustrated in FIG. 1 is applied to a server 100 is explained as a second embodiment.

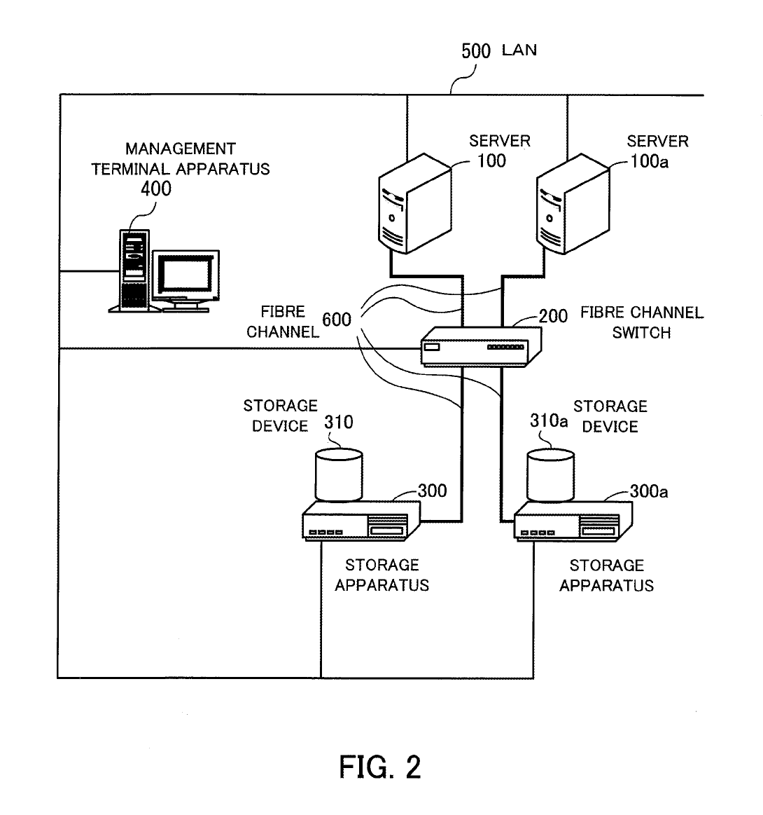

FIG. 2 illustrates a system configuration of the second embodiment. A storage system illustrated in FIG. 2 has a plurality of (for example, two) servers 100 and 100a, at least one (for example, one) fibre channel switch 200, a plurality of (for example, two) storage apparatuses 300 and 300a, and at least one (for example, one) management terminal apparatus 400.

The servers 100 and 100a, the fibre channel switch 200, the storage apparatuses 300 and 300a, and the management terminal apparatus 400 are connected to one another via a LAN 500 so that control data to control the storage system may be communicated. Further, the servers 100 and 100a, the fibre channel switch 200, and the storage apparatuses 300 and 300a are connected to one another via a fibre channel 600 so that user data used in the servers 100 and 100a and also stored in the storage apparatuses 300 and 300a may be communicated.

To the servers 100 and 100a, the storage apparatuses 300 and 300a are connected through the fibre channel 600. To the servers 100 and 100a, storage regions of the storage apparatuses 300 and 300a are allocated exclusively. Whereas it is possible for the server 100 to access the storage region allocated to the server 100, it is not possible to access the storage region allocated to the server 100a. Similarly, whereas it is possible for the server 100a to access the storage region allocated to the server 100a, it is not possible to access the storage region allocated to the server 100. It is possible for the servers 100 and 100a to access the allocated storage regions of the storage apparatuses 300 and 300a and write user data, and to access the allocated storage regions and read written user data. The servers 100 and 100a may use data stored in the storage regions allocated thereto, respectively, for themselves. Further, the servers 100 and 100a may access data stored in the storage regions in response to a request from clients (not illustrated) connected to the servers 100 and 100a in place of the clients. The servers 100 and 100a have physical ports, respectively, and also may set virtual ports when necessary.

The fibre channel switch 200 is a switch configured to relay data transmitted from the servers 100 and 100a and data transmitted from the storage apparatuses 300 and 300a. Further, the fibre channel switch 200 has a physical port and also may set a virtual port when necessary. The fibre channel switch 200 exclusively connects one of the servers 100 and 100a and part or the whole of the storage regions of the storage apparatuses 300 and 300a by performing zoning to set a zone between the servers 100 and 100a and the storage apparatuses 300 and 300a using the physical port and the virtual port.

The storage apparatuses 300 and 300a have storage devices 310 and 310a, respectively, and also store data transmitted from the servers 100 and 100a via the fibre channel switch 200 and the fibre channel 600 in the storage regions of the storage devices 310 and 310a, respectively. It is possible for the storage apparatuses 300 and 300a to allocate storage regions of the storage devices 310 and 310a to the server. Further, it is possible for the storage apparatuses 300 and 300a to divide the storage regions of the storage devices 310 and 310a, respectively, and also to allocate the divided storage regions to the different servers, respectively. It is not possible for a server other than the server to which the storage region is allocated to access the storage region. The storage apparatuses 300 and 300a have physical ports, respectively, and also may set a virtual port when necessary. The storage devices 310 and 310a are hard disk drives and store user data of the system transmitted from the servers 100 and 100a. It may also be possible to configure the storage devices 310 and 310a as a storage region of a magnetic storage apparatus, an optical disc, a magneto-optical storage medium, a semiconductor memory, and another storage apparatus from or to which data may be read or written, other than the hard disk drive. The magnetic storage apparatus includes a flexible disc, a magnetic tape, etc. The optical disk includes a DVD, a DVD-RAM, a CD-ROM, a CD-R/RW, etc. The magneto-optical storage medium includes an MO etc. The semiconductor memory includes a RAM, which is a volatile semiconductor memory, a writable nonvolatile semiconductor memory etc., such as a Flash SSD.

The management terminal apparatus 400 is a computer operated by an administrator of the storage system. It is possible for the administrator of the storage system to access the servers 100 and 100a, the fibre channel switch 200, and the storage apparatuses 300 and 300a and to perform various settings necessary for the operation by operating the management terminal apparatus 400.

Note that, in the storage system of the present embodiment, user data is transmitted and received by the fibre channel and also data is transferred within the storage system by the fibre channel switch 200, however, this is not limited, and it may also be possible to perform transmission and reception of user data by another communication system, such as, for example, iSCSI (Internet Small Computer System Interface).

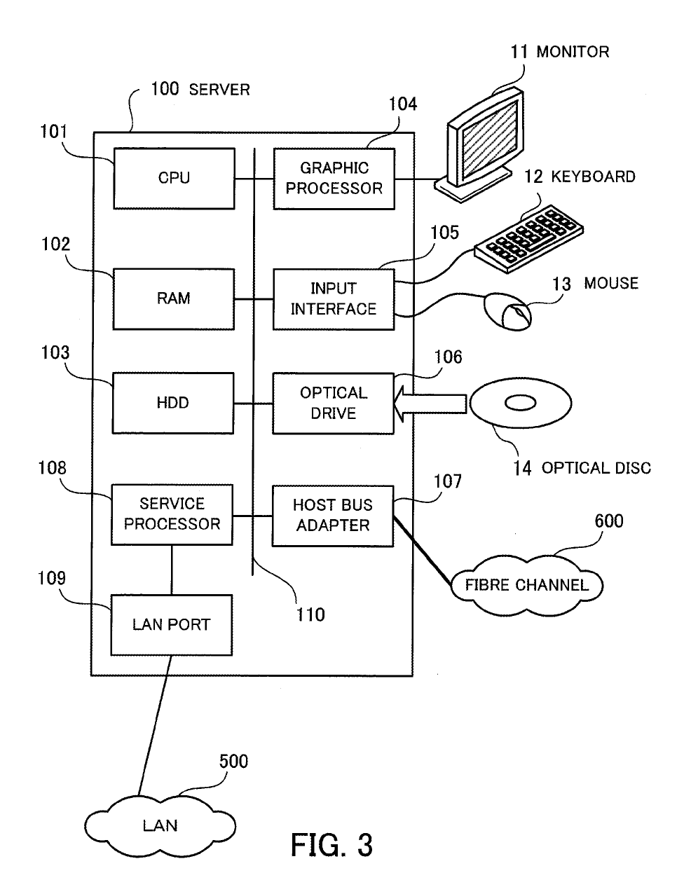

FIG. 3 illustrates a hardware configuration of the server of the second embodiment. The whole of the server 100 is controlled by a CPU (Central Processing Unit) 101. To the CPU 101, a RAM 102 and a plurality of peripherals are connected via a bus 110.

The RAM 102 is used as a main storage apparatus of the server 100. In the RAM 102, at least part of programs of an OS (Operating System) and application programs executed by the CPU 101 is stored temporarily. Further, in the RAM 102, various kinds of data necessary for processing by the CPU 101 are stored.

Peripherals connected to the bus 110 include a hard disk drive 103, a graphic processor 104, an input interface 105, an optical drive 106, a host bus adapter 107, and a service processor 108.

The HDD 103 magnetically writes and reads data to and from a built-in disc. The HDD 103 is used as a secondary storage apparatus of the server 100. In the HDD 103, programs of the OS, application programs, and various kinds of data are stored. As a secondary storage apparatus, a semiconductor storage apparatus, such as a flash memory, may also be used.

To the graphic processor 104, a monitor 11 is connected. The graphic processor 104 causes the monitor 11 to display an image on the screen thereof in accordance with a command from the CPU 101. The monitor 11 includes a display unit using a CRT (Cathode Ray Tube), a liquid crystal display unit, etc.

To the input interface 105, a keyboard 12 and a mouse 13 are connected. The input interface 105 transmits signals sent from the keyboard 12 and the mouse 13 to the CPU 101. Note that, the mouse 13 is an example of a pointing device and another pointing device may be used. As another pointing device, mention is made of a touch panel, a tablet, a touch pad, a track ball, etc.

The optical drive 106 reads data recorded on an optical disc 14 by utilizing laser beams etc. The optical disc 14 is a portable storage medium on which data is recorded so that data may be read by reflection of light. The optical disc 14 includes a DVD, a DVD-RAM, a CD-ROM, a CD-R/RW, etc.

The host bus adapter 107 is connected to the fibre channel 600. The host bus adapter 107 performs transmission and reception of user data between the CPU 101 and the storage apparatuses 300 and 300a via the fibre channel switch 200 and the fibre channel 600.

The service processor 108 is a processor configured to operate independently of the OS of the CPU 101 and the server 100 and to control the server 100 and the storage system. To the service processor 108, a LAN port 109 is connected. The service processor 108 controls the server 100 and the storage system by transmitting and receiving commands and control data via the LAN port 109.

The LAN port 109 is connected to the LAN 500. The LAN port 109 performs transmission and reception of commands and control data between the service processor 108 and the fibre channel switch 200 or between the service processor 108 and the storage apparatuses 300 and 300a via the LAN 500. In the present embodiment, the service processor 108 performs transmission and reception of commands and control data by LAN communication via the LAN port 109, but, this is not limited and transmission and reception of commands and control data may be performed by a fibre channel or by another communication system. In this case, the server 100 uses a communication interface corresponding to a communication system to perform transmission and reception of commands and control data in place of the LAN port 109.

Although FIG. 3 illustrates the hardware configuration of the server 100, the server 100a and the management terminal apparatus 400 have a similar hardware configuration. By the hardware configuration described above, the processing function of the present embodiment may be implemented.

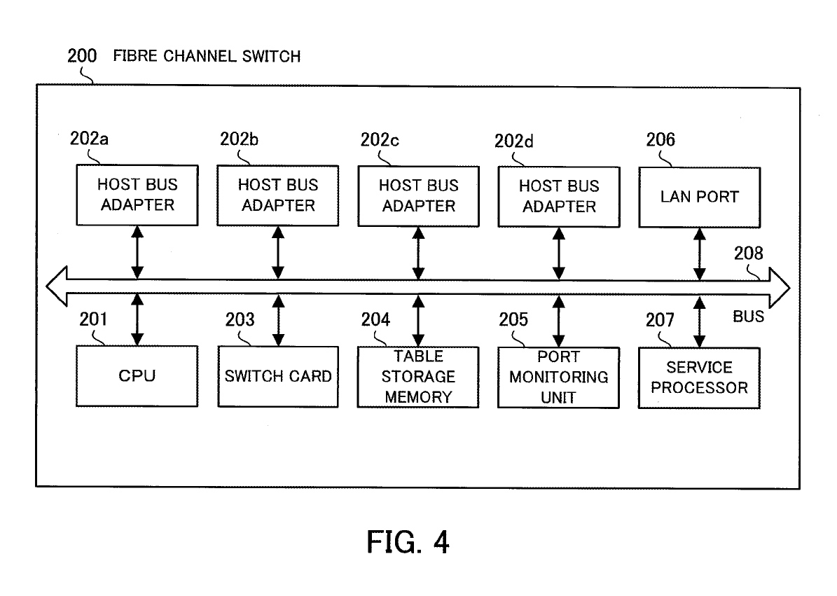

FIG. 4 illustrates a hardware configuration of the fibre channel switch of the second embodiment. The fibre channel switch 200 has a CPU 201, host bus adapters 202a, 202b, 202c, and 202d, a switch card 203, a table storage memory 204, a port monitoring unit 205, a LAN port 206, a service processor 207, and a bus 208.

The CPU 201 controls the whole of the fibre channel switch 200. The CPU 201 performs processing by programs. The CPU 201 executes programs relating to transfer of data within the storage system held in a memory, not illustrated, using data held also in the same memory.

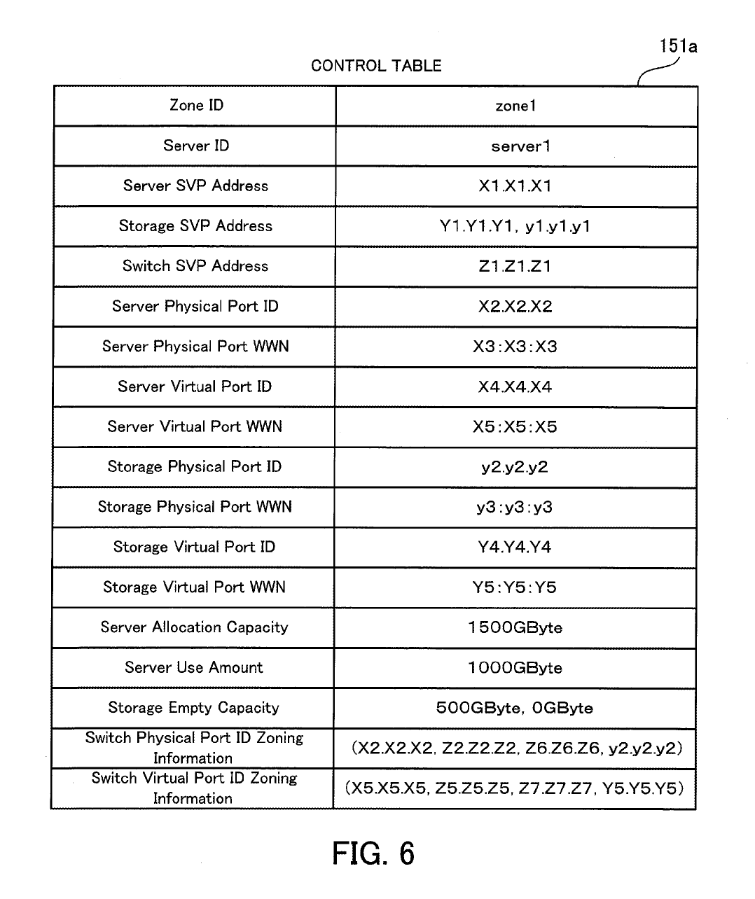

The table storage memory 204 stores a plurality of tables. The tables stored in the table storage memory 204 include a table to manage a configuration of a zone configured in the storage system, a table to determine a transfer destination of data, a table to store information indicative of a transfer destination of data, and a table to store control data, such as a table to store control information, to be described in FIG. 6.

To the bus 208, the CPU 201, the host bus adapters 202a, 202b, 202c, and 202d, the switch card 203, the table storage memory 204, the port monitoring unit 205, the LAN port 206, and the service processor 207 are connected.

The host bus adapters 202a, 202b, 202c, and 202d each have one or a plurality of (for example, four) communication ports of the fibre channel. One physical link of the fibre channel may be connected to each communication port. To each of the host bus adapters 202a, 202b, 202c, and 202d, a unique node WWN (World Wide Name) is allocated and also a unique port WWN is allocated to each port. The WWN is a unique 8-Byte address allocated to each apparatus or to each port for the apparatus used in communication by the fibre channel. Each of the host bus adapters 202a, 202b, 202c, and 202d monitors its communication port and acquires a frame of user data. Each of the host bus adapters 202a, 202b, 202c, and 202d has a buffer therein to temporarily hold frames in case frames arrive simultaneously at a plurality of communication ports. Then, the host bus adapters 202a, 202b, 202c, and 202d send the acquired frames to the switch card 203.

The switch card 203 has a table indicating the destination of a frame. The switch card 203 stores the transmission source address of the received frame and identification information of the communication port or the logical link at which the frame has arrived in association with each other in the table. The contents of the table are set statically in advance.

Upon receipt of a frame from one of the host bus adapters 202a, 202b, 202c, and 202d, the switch card 203 refers to the table and determines the transfer destination of the frame. Here, if the determined transfer destination is a virtual port, the switch card 203 refers to the table stored in the table storage memory 204 and determines the specific host bus adapters 202a, 202b, 202c, and 202d and the communication port used for transfer. After that, the switch card 203 sends the frame to the determined host bus adapters 202a, 202b, 202c, and 202d.

The host bus adapters 202a, 202b, 202c, and 202d having received the frame send the received frame to the transmission destination from the determined communication port.

The port monitoring unit 205 monitors the communication ports of the host bus adapters 202a, 202b, 202c, and 202d and detects the occurrence of anomaly and trouble in the communication ports and communication passages connected.

The service processor 207 receives, via the LAN port 206, commands and control data transmitted from the management terminal apparatus 400 used by an administrator and the servers 100 and 100a, and also returns the result of execution of the commands to the management terminal apparatus 400.

In the storage system of the present embodiment, user data is transmitted and received by the fibre channel and also data is transferred within the storage system by the fibre channel switch 200, but, this is not limited, and it may also be possible to perform transmission and reception of user data by another communication system, such as, for example, iSCSI. In this case, in the storage system, a switch corresponding to the communication system by which to perform transmission and reception of user data is used in place of the fibre channel switch 200.

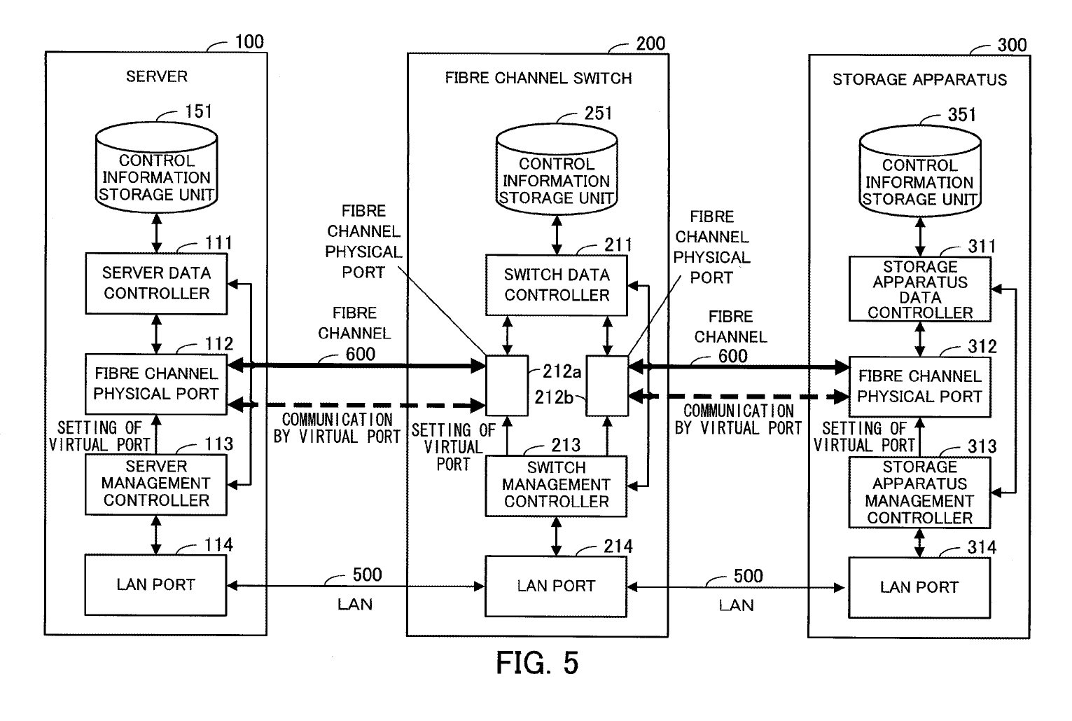

FIG. 5 is a block diagram illustrating the function of the server of the second embodiment. In the storage system of the present embodiment, a plurality of servers, not illustrated, including the server 100 reads and writes data from and to the storage regions of a plurality of storage apparatuses, not illustrated, including the storage apparatus 300 connected by an electric or optical communication line via the fibre channel switch 200. The server 100 of the present embodiment has a server data controller 111, a fibre channel physical port 112, a server management controller 113, and a LAN port 114. The fibre channel switch 200 has a switch data controller 211, fibre channel physical ports 212a and 212b, a switch management controller 213, and a LAN port 214. The storage apparatus 300 has a storage apparatus data controller 311, a fibre channel physical port 312, a storage apparatus management controller 313, and a LAN port 314.

The server data controller 111 of the server 100 performs transmission and reception of data with the storage apparatus 300 having a storage region allocated to the server 100 by the fibre channel physical port 112 or a virtual port set at the fibre channel physical port 112.

The fibre channel physical port 112 is connected to the fibre channel physical port 212a by an electric or optical communication line and transmits and receives data by communicating with the storage apparatus 300. Further, at the fibre channel physical port 112, a virtual port configured to transmit and receive data by communicating with the storage apparatus 300 via the fibre channel switch 200 is set by the server management controller 113. The fibre channel physical port 112 and the virtual port set at the fibre channel physical port 112 perform individual communications logically independent of each other. Data communicated by the fibre channel physical port 112 is not transmitted or received at the connection destination of the virtual port (for example, unallocated storage region of the storage apparatus 300 allocated to the server 100) set by a virtual port to be set. Further, data communicated by the virtual port to be set is not transmitted or received at the connection destination of the fibre channel physical port 212a (for example, a storage region of another storage apparatus (not illustrated) or a storage region other than the unallocated storage region of the storage apparatus 300 allocated to the server 100). This also applies to the following fibre channel physical ports 212a, 212b, and 312 and the virtual ports to be set thereat, respectively.

The server management controller 113 calculates a use rate based on the storage capacity of the allocated storage region of the storage apparatus 300 and the amount of use of the storage region. Next, the server management controller 113 determines whether or not to perform allocation based on the calculated use rate.

When determining to perform allocation, the server management controller 113 allocates an unallocated storage region allocated to none of the severs 100 to the server 100, and also sets a virtual port at the fibre channel physical port 112 and connects the server 100 to the unallocated storage region that is allocated by the set virtual port. The virtual port set at the fibre channel physical port 112 is set so as to exclusively connect the server 100 and the unallocated storage region. That is, it is not possible for another server (not illustrated) or another storage apparatus of the storage system to access the set virtual port or the unallocated storage region allocated to the server 100.

Here, when determining to perform allocation, the server management controller 113 makes a request to each storage apparatus of the storage system for control information having information indicative of the amount of the unallocated storage region each storage apparatus has. Next, the server management controller 113 determines a storage apparatus (for example, storage apparatus 300) having the largest unallocated storage region based on the control information transmitted from each storage apparatus in response to the request, and allocates the unallocated storage region of the determined storage apparatus 300 to the server 100 and also sets a virtual port. Next, the server management controller 113 makes a request to the storage apparatus 300 having the unallocated storage region to be allocated to the server 100 for control information having information indicative of the virtual port that the storage apparatus 300 sets and connects the server 100 to the unallocated storage region that is allocated by connecting the set virtual port and the virtual port of the storage apparatus 300 based on the control information.

In addition, the server management controller 113 determines whether or not to perform disconnection based on the calculated use rate. When determining to perform disconnection, the server management controller 113 disconnects part or the whole of the empty region in the storage region allocated to the server 100 in a state capable of being allocated to another server to produce an unallocated storage region.

The LAN port 114 is mutually connected to the LAN port 214 and the LAN port 314 by the LAN 500 and transmits and receives control data, such as control information, between the server 100 and the storage apparatus 300. The server management controller 113 allocates an unallocated storage region to the server 100 and connects the server 100 to the unallocated storage region by performing transmission and reception of control information with the fibre channel switch 200 and the storage apparatus 300 by the LAN port 114.

A control information storage unit 151 stores control information which is transmitted to and received from the fibre channel switch 200 and the storage apparatus 300 and which controls allocation and disconnection in the server 100. The control information has information indicative of the amount of the unallocated storage region each storage apparatus has, information indicative of the virtual port set by each apparatus of the storage system, etc., to be described later in detail in FIG. 6.

The server 100a has the same configuration as that of the server 100, and therefore, explanation is omitted here.

The fibre channel switch 200 relays data between the server 100 and the storage apparatus 300 and also controls allocation.

The switch data controller 211 performs transmission and reception of data with the storage apparatus 300 having the storage region allocated to the server 100 by the fibre channel physical port 212a or a virtual port set at the fibre channel physical port 212a, and also performs transmission and reception of data with the storage apparatus 300 by the fibre channel physical port 212b or a virtual port set at the fibre channel physical port 212b.

The fibre channel physical port 212a is connected to the fibre channel physical port 112 by an electric or optical communication line and transmits and receives data by communicating with the server 100. In addition, at the fibre channel physical port 212a, a virtual port configured to transmit and receive data by communicating with the server 100 is set by the switch management controller 213. The fibre channel physical port 212b is connected to the fibre channel physical port 312 by an electric or optical communication line and transmits and receives data by communicating with the storage apparatus 300. In addition, at the fibre channel physical port 212b, a virtual port configured to transmit and receive data by communicating with the storage apparatus 300 is set by the switch management controller 213. The fibre channel switch 200 relays transmission and reception of data between apparatuses of the storage system, such as the server 100 and the storage apparatus 300, by the fibre channel physical ports 212a and 212b, and the virtual ports set thereat, respectively, and other physical ports and virtual ports, not illustrated.

When a request is made from the server 100 for connection of an unallocated storage region, the switch management controller 213 connects the server 100 having made the request and the unallocated storage region by the virtual port set at the fibre channel physical port 212a and the virtual port set at the fibre channel physical port 212b.

The LAN port 214 is mutually connected to the LAN port 114 and the LAN port 314 by the LAN 500 and transmits and receives control data, such as control information to control the storage system, between the server 100 and the fibre channel switch 200.

A control information storage unit 251 stores control information transmitted and received between the server 100 and the storage apparatus 300.

The storage apparatus data controller 311 of the storage apparatus 300 performs transmission and reception of data with the server 100 by the fibre channel physical port 312 or a virtual port set at the fibre channel physical port 312.

The fibre channel physical port 312 is connected to the fibre channel physical port 212b by an electric or optical communication line and transmits and receives data by communicating with the server 100. At the fibre channel physical port 312, a virtual port configured to transmit and receive data by communicating with the server 100 via the fibre channel switch 200 is set by the storage apparatus management controller 313.

When a request is made from the server 100 for allocation of an unallocated storage region, the storage apparatus management controller 313 sets a virtual port and connects the unallocated storage region requested to be allocated and the server 100 having made the request by the virtual port.

The LAN port 314 is mutually connected to the LAN port 114 and the LAN port 214 by the LAN 500 and transmits and receives control data, such as control information to control the storage system, between the server 100 and the storage apparatus 300.

A control information storage unit 351 stores control information transmitted and received to and from the server 100 and the fibre channel switch 200.

The storage apparatus 300 has a storage region from or to which data may be read or written by control of the storage apparatus data controller 311. It is possible to configure the storage region of the storage apparatus 300 as a storage region of a magnetic storage apparatus, an optical disc, a magneto-optical storage medium, a semiconductor memory, and another storage apparatus from or to which data may be read or written. The magnetic storage apparatus includes a hard disk drive, a flexible disc, a magnetic tape, etc. The optical disc includes a DVD, a DVD-RAM, a CD-ROM, a CD-R/RW, etc. The magneto-optical storage medium includes an MO etc. The semiconductor memory includes a RAM, which is a volatile semiconductor memory, a writable nonvolatile semiconductor memory etc., such as a Flash SSD. The storage region may be a RAID having a plurality of storages or a JBOD.

The storage apparatus 300a has the same configuration as that of the storage apparatus 300, and therefore, explanation is omitted here.

When determining to perform allocation, the server management controller 113 of the present embodiment allocates an unallocated storage region allocated to none of servers to the server 100. However, this is not limited and when determining to perform allocation, the server management controller 113 may make a request to disconnect part or the whole of the empty region in the storage region allocated to another server in a state capable of being allocated to the server 100 to produce an unallocated storage region, and may allocate the unallocated storage region to the server 100 and also set a virtual port, and may connect the server 100 to the unallocated storage region allocated by the set virtual port.

FIG. 6 illustrates a control table of the second embodiment. A control table 151a illustrated in FIG. 6 is stored in the control information storage unit 151 the server 100 has. The control table 151a is a table configured to store control information indicative of information relating to setting of a zone set in the storage system. The control information is updated by the server data controller 111 in accordance with the change in the situation of the storage system. Further, the server 100 sets a zone of the storage system based on the control information.

In the control table 151a, as items, “Zone ID”, “Server ID”, “Server SVP Address”, “Storage SVP Address”, “Switch SVP Address”, “Server Physical Port ID”, “Server Physical Port WWN”, “Server Virtual Port ID”, “Server Virtual Port WWN”, “Storage Physical Port ID”, “Storage Physical Port WWN”, “Storage Virtual Port ID”, “Storage Virtual Port WWN”, “Server Allocation Capacity”, “Server Use Amount”, “Storage Empty Capacity”, “Switch Physical Port ID Zoning Information”, and “Switch Virtual Port ID Zoning Information” are provided. In the control table 151a, the pieces of information arranged side by side in the transverse direction of each item are associated with one another as control information. The control information of the present embodiment is set for each server.

Zone ID is a code allocated so that a zone (for example, zone 1) may be uniquely identified in the storage system.

Server ID is a code allocated so that a server (for example, server 100) may be uniquely identified in the storage system.

Server SVP Address is an IP address set for a LAN port (for example, LAN port 109) to be connected to a service processor (for example, service processor 108) of a server (for example, server 100).

Storage SVP Address is an IP address set for a LAN port (not illustrated) to be connected to a service processor (not illustrated) of a storage apparatus (for example, storage apparatuses 300 and 300a) belonging to the same zone as that of the server. For example, Storage SVP Address of the storage apparatus 300 is assumed to be “Y1. Y1. Y1” and Storage SVP Address of the storage apparatus 300a is assumed to be “y1. y1. y1”. In the example of FIG. 6, it is assumed that the server 100 is connected to the storage apparatus 300a due to zoning by a physical port and is also connected to the storage apparatus 300 due to zoning by a virtual port.

Switch SVP Address is an IP address set for a LAN port (for example, LAN port 206) to be connected to a service processor (for example, service processor 207) of a fibre channel switch (for example, fibre channel switch 200) set in the same zone as that of the server.

Server Physical Port ID is a port ID allocated to be uniquely identifiable in the storage system for a physical port of a server configuring a zone set by zoning by the physical port.

Server Physical Port WWN is a code allocated uniquely to a physical port of a server configuring a zone set by zoning by the physical port.

Here, in the case where a plurality of zones by the physical port is set for the server, Server Physical Port ID and Server Physical Port WWN are set in the control information in the number corresponding to that of zones by the physical port.

Server Virtual Port ID is a port ID allocated to be uniquely identifiable in the storage system for a virtual port of a server configuring a zone set by zoning by the virtual port (for example, for a fibre channel, NPIV (N Port ID Virtualization) is used as Virtual Port ID).

Server Virtual Port WWN is a code allocated uniquely to a virtual port of a server configuring a zone set by zoning by the virtual port.

Here, in the case where a plurality of zones by the virtual port is set for the server, Sever Virtual Port ID and Server Virtual Port WWN are set in the control information in the number corresponding to that of zones by the virtual port.

Storage Physical Port ID is a port ID allocated to be uniquely identifiable in the storage system for a physical port of a storage apparatus (for example, storage apparatus 300a) configuring a zone set by zoning by the physical port for a server (for example, server 100).

Storage Physical Port WWN is a code allocated uniquely to a physical port of a storage apparatus (for example, storage apparatus 300a) configuring a zone set by zoning by the physical port for a server (for example, server 100).

Here, in the case where a plurality of zones by the physical port is set for the server, Storage Physical Port ID and Storage Physical Port WWN are set in the control information in the number corresponding to that of zones by the physical port.

Storage Virtual Port ID is a port ID allocated to be uniquely identifiable in the storage system for a virtual port of a storage apparatus (for example, storage apparatus 300a) configuring a zone set by zoning by the virtual port for a server (for example, server 100) (for example, for a fibre channel, NPIV is used as Virtual Port ID).

Storage Virtual Port WWN is a code allocated uniquely to a virtual port of a storage apparatus (for example, storage apparatus 300a) configuring a zone set by zoning by the virtual port for a server (for example, server 100).

Here, in the case where a plurality of zones by the virtual port is set for the server, Storage Virtual Port ID and Storage Virtual Port WWN are set in the control information in the number corresponding to that of zones by the virtual port.

Server Allocation Capacity is information indicative of the total storage capacity by GByte of the storage region of the storage apparatus allocated to the server by the zone by the physical port and the zone by the virtual port.

Server Use Amount is information indicative of the storage capacity by GByte used actually and to which data is written of the storage capacity of the storage region of the storage device of the storage apparatus allocated to the server by the zone by the physical port and the zone by the virtual port.

Storage Empty Capacity is information indicative of the empty capacity by GByte of the storage region of the storage device each storage apparatus of the storage system has.

Switch Physical Port ID Zoning Information is information indicative of the physical port configuring a zone by the physical port. Switch Physical Port ID Zoning Information indicates the server physical port, the fibre channel switch physical port, and the storage apparatus physical port used in the zone by the physical port. Consequently, by Switch Physical Port ID Zoning Information, the zone to which the server indicated by the control information belongs is identified using the physical port.

Switch Virtual Port ID Zoning Information is information indicative of the virtual port configuring a zone by the virtual port. Switch Virtual Port ID Zoning Information indicates the server virtual port, the fibre channel switch virtual port, and the storage apparatus virtual port used in the zone by the virtual port. Consequently, by Switch Virtual Port ID Zoning Information, the zone to which the server indicated by the control information belongs is identified using the virtual port.

Note that, although FIG. 6 illustrates the control table 151a stored in the control information storage unit 151 of the server 100, the control information storage unit (not illustrated) of the server 100a, the control information storage unit 251 of the fibre channel switch 200, the control information storage unit 351 of the storage apparatus 300, the control information storage unit (not illustrated) of the storage apparatus 300a, and the control information storage unit of the management terminal apparatus 400 also store similar control information. As the server 100 does, the server 100a, the fibre channel switch 200, the storage apparatuses 300 and 300a, and the management terminal apparatus 400 update the control information in accordance with a change in the situation of the storage system and also set a zone of the storage system based on the control information.

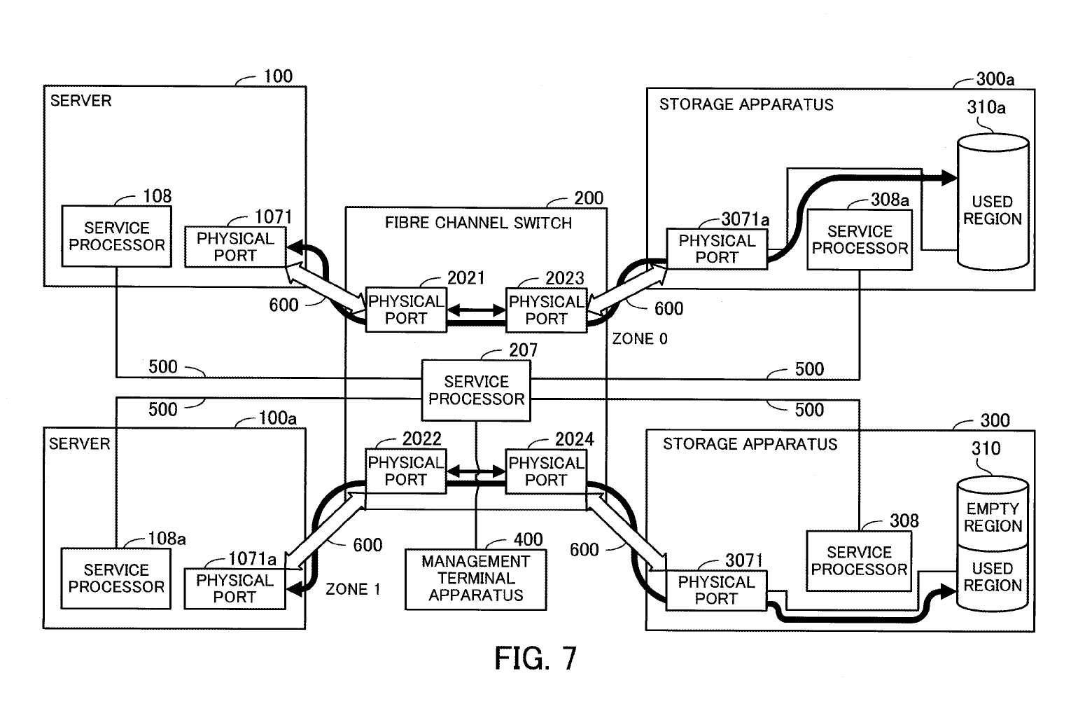

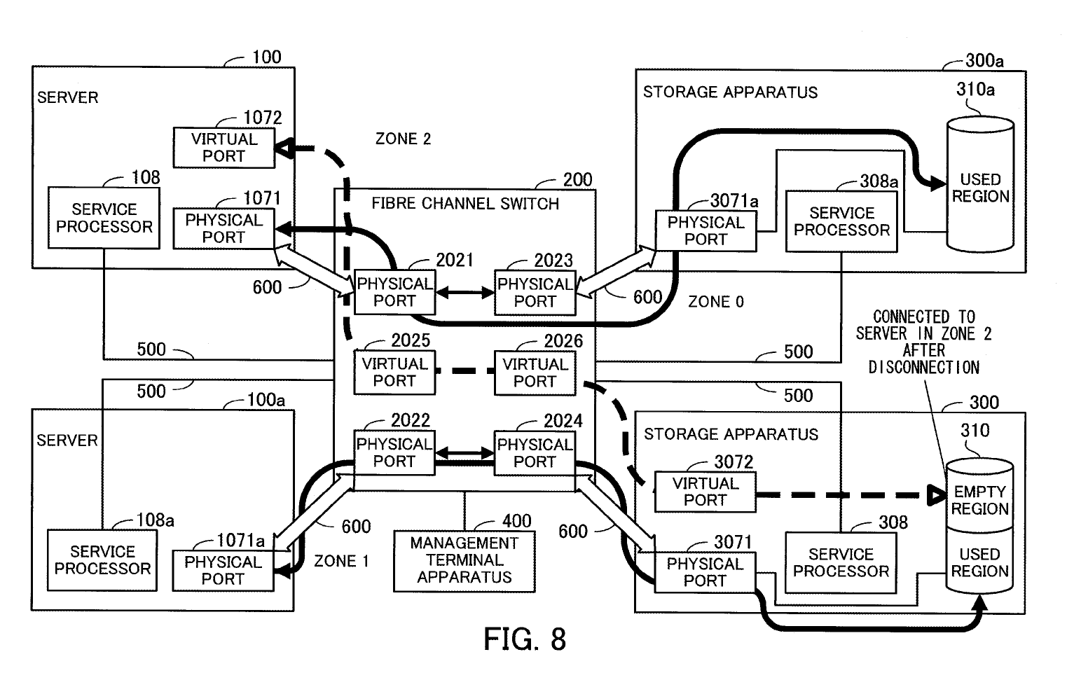

FIG. 7 and FIG. 8 illustrate connections between servers and storage regions of storage apparatuses based on zones of the second embodiment. FIG. 7 illustrates connections between servers and storage regions of storage apparatuses based on zones by physical ports. FIG. 8 illustrates connections between servers and storage regions of storage apparatuses based on zones by physical ports and zones by virtual ports.

First, with reference to FIG. 7, connections between servers and storage regions of storage apparatuses based on zones by physical ports in the storage system of the present embodiment are explained.

As illustrated in FIG. 7, the server 100 has a physical port 1071 and the service processor 108. The server 100a has a physical port 1071a and a service processor 108a. The fibre channel switch 200 has physical ports 2021, 2022, 2023, and 2024 and the service processor 207. The storage apparatus 300 has a physical port 3071, a service processor 308 configured to perform control of the storage apparatus 300 and the storage system, and the storage device 310. The storage apparatus 300a has a physical port 3071a, a service processor 308a configured to perform control of the storage apparatus 300a and the storage system, and the storage device 310a.

The physical port 1071 is connected to the physical port 2021 by the fibre channel 600. The physical port 1071a is connected to the physical port 2022 by the fibre channel 600. The physical port 3071 is connected to the physical port 2024 by the fibre channel 600. The physical port 3071a is connected to the physical port 2023 by the fibre channel 600. The service processors 108, 108a, 207, 308, and 308a, and the management terminal apparatus 400 are connected by the LAN 500.

In addition, it is assumed that: the storage devices 310 and 310a have storage regions each having storage capacity of 1,000 GByte: the storage region of the storage device 310a is fully used and there is no empty capacity; in the storage device 310, 400 GByte of the storage region is used and the empty region is 600 GByte; and the empty region is connected to the server 100a, but, not used.

Here, it is assumed that the server 100 is connected to the storage device 310a of the storage apparatus 300a by the physical port 1071 via the physical ports 2021 and 2023 of the fibre channel switch 200 and the physical port 3071a of the storage apparatus 300a and a zone 0 is set as illustrated in FIG. 7. Further, it is assumed that: the full storage region of the storage device 310a is allocated to the server 100; and the server 100a is connected to the storage device 310 of the storage apparatus 300 by the physical port 1071a via the physical ports 2022 and 2024 of the fibre channel switch 200 and the physical port 3071 of the storage apparatus 300 and a zone 1 is set.

Next, with reference to FIG. 8, connections between servers and storage regions of storage apparatuses based on zones by virtual ports in the storage system of the present embodiment are explained.

In FIG. 8, it is assumed that a virtual port 1072 of the fibre channel is set in the server 100. Further, it is assumed that: virtual ports 2025 and 2026 of the fibre channel are set in the fibre channel switch 200; and a virtual port 3072 of the fibre channel is set in the storage apparatus 300.

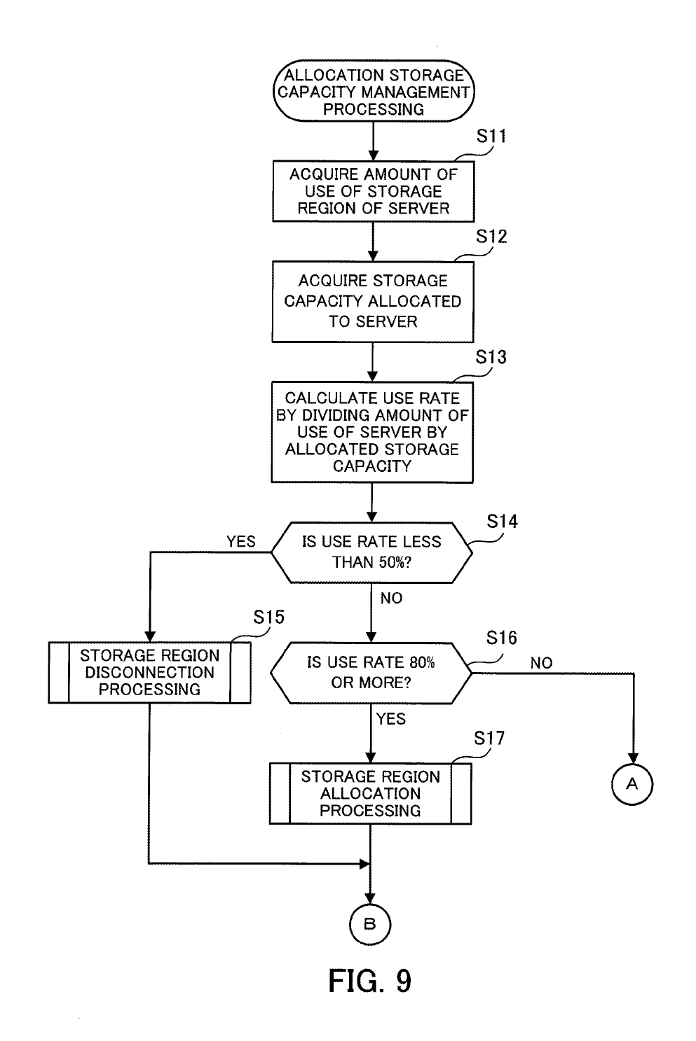

In addition, in FIG. 8, it is assumed that the amount of use of the storage allocated to the server 100 is large, which satisfies a predetermined condition for receiving allocation of a new storage region, to be described later in detail in FIG. 9. Further, based on the above, in addition to the zones 0 and 1 by the physical ports of FIG. 7, it is assumed that: the empty region has been connected to the server 100a at that point of time of FIG. 7, but, the amount of use of the storage of the server 100a is small, and therefore, the empty region is disconnected to become an unallocated storage region; and the server 100 is connected to the unallocated storage region of the storage device 310 of the storage apparatus 300, which has been connected to the server 100a at that point of time of FIG. 7, but, now disconnected, by the physical port 1072 via the virtual ports 2025 and 2026 of the fibre channel switch 200 and the virtual port 3072 of the storage apparatus 300, and a zone 2 is set. Due to this, the empty region of the storage device 310 is connected to the server 100 in the zone 2 after being disconnected from the server 100a to which the empty region has been connected in the zone 1. Further, it is also assumed that the full storage region of the storage device 310a and the unallocated storage region of the storage device 310 are allocated to the server 100.

In addition, it is also assumed that, as in FIG. 7, the server 100a is connected to the storage device 310 of the storage apparatus 300 by the physical port 1071a via the physical ports 2022 and 2024 of the fibre channel switch 200 and the physical port 3071 of the storage apparatus 300 and the zone 1 is set.

As described above, the empty region of the storage device 310 having been connected to the server 100a in the zone 1 by the physical port is disconnected from the server 100a and is connected to the server 100 in the zone 2 by the virtual port, and thus, allocated to the server 100, and therefore, it is made possible to newly allocate the empty region having been allocated to the server 100a to the server 100.

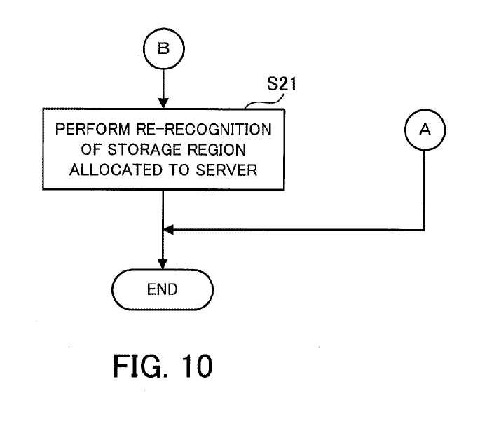

FIG. 9 and FIG. 10 are a flowchart illustrating a procedure of allocation storage region management processing of the second embodiment. The servers 100 and 100a of the present embodiment calculate a use rate of the storage region by acquiring the storage capacities of the storage regions of the storage apparatuses 300 and 300a allocated to the server 100 and amounts of use of the storage regions, and disconnect part of the storage regions in accordance with the use rate or newly receive allocation of the storage region. The servers 100 and 100a of the present embodiment perform allocation storage capacity management processing individually during the operation at predetermined term intervals or at an arbitrary momentum. In the following, the allocation storage capacity management processing illustrated in FIG. 9 and FIG. 10 is explained in the order of step numbers of the flowchart. Here, it is assumed that the allocation storage capacity management processing is first started in the server 100.

(Step S11) The server management controller 113 acquires the amount of use in the storage region allocated to the server 100 from the storage apparatus (for example, storage apparatuses 300 and 300a) having the storage region allocated to the server 100.

(Step S12) The server management controller 113 acquires the storage capacity of the storage region allocated to the server 100 from the storage apparatuses 300 and 300a having the storage region allocated to the server 100.

(Step S13) The server management controller 113 calculates a use rate by dividing the amount of use acquired at step S11 by the storage capacity acquired at step S12.

(Step S14) The server management controller 113 determines whether or not the use rate calculated at step S13 is less than a predetermined lower limit value (for example, 50%). When the use rate is less than the predetermined lower limit value (Step S14 YES), the processing is advanced to step S15. On the other hand, when the use rate is equal to or more than the predetermined lower limit value (step S14 NO), the processing is advanced to step S16.

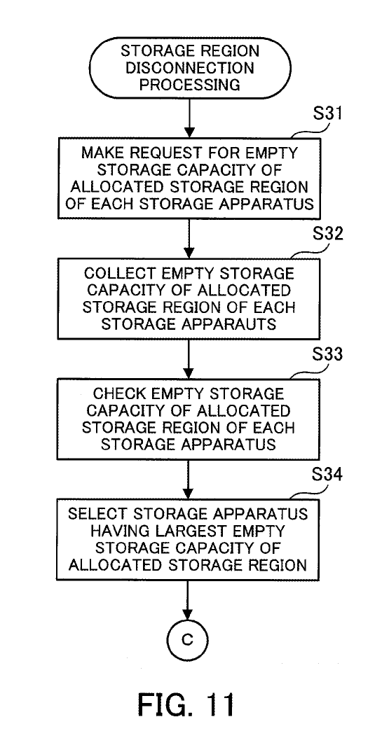

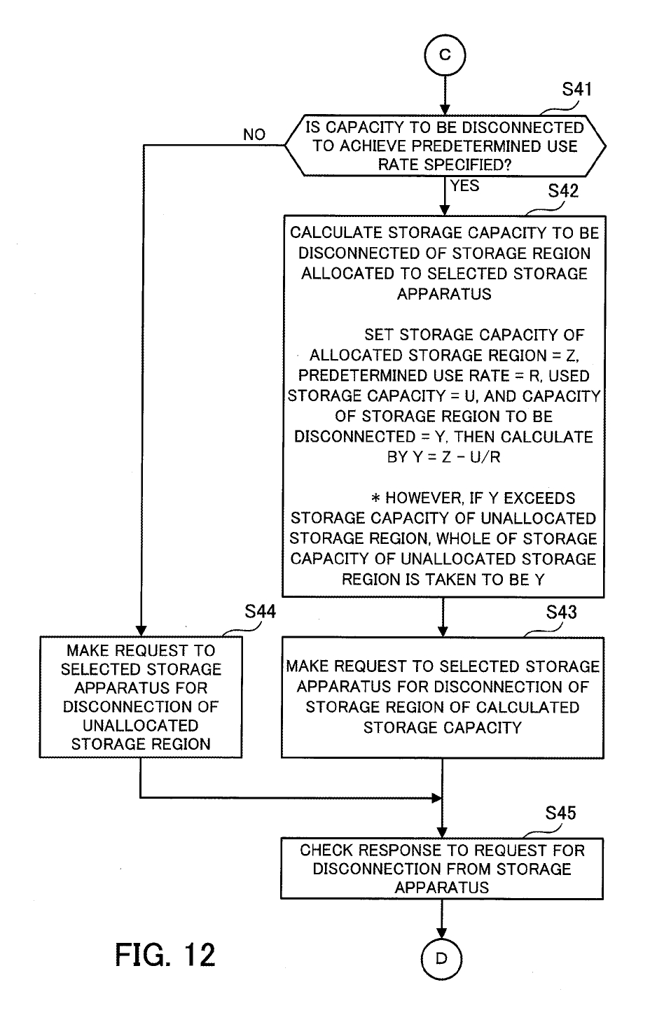

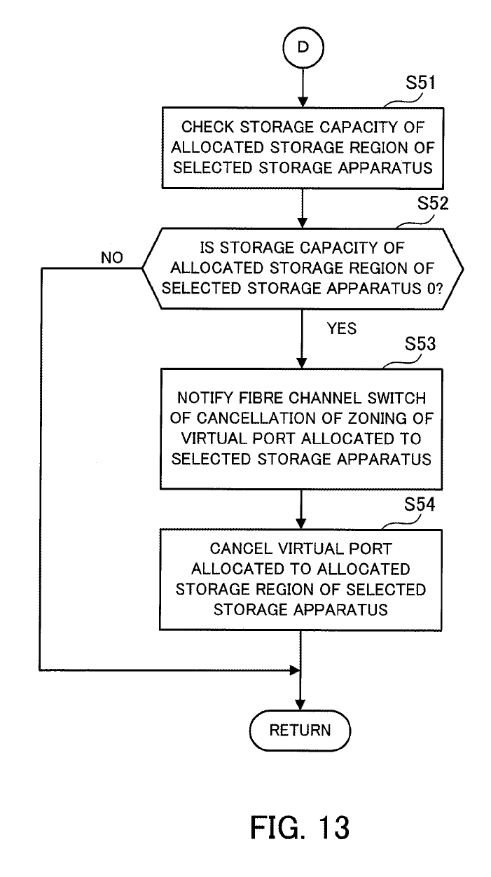

(Step S15) The server management controller 113 performs storage region disconnection processing (to be described later in FIG. 11 to FIG. 13) to disconnect part of the allocated storage region not used by the storage device (for example, storage device 310a) of the storage apparatus (for example, storage apparatus 300a). After that, the processing is advanced to step S21.

(Step S16) The server management controller 113 determines whether or not the use rate calculated at step S13 is equal to or more than a predetermined upper limit value (for example, 80%). When the use rate is equal to or more than the predetermined upper limit value (step S16 YES), the processing is advanced to S17. On the other hand, when the use rate is less than the predetermined upper limit value (step S16 NO), the processing is exited.

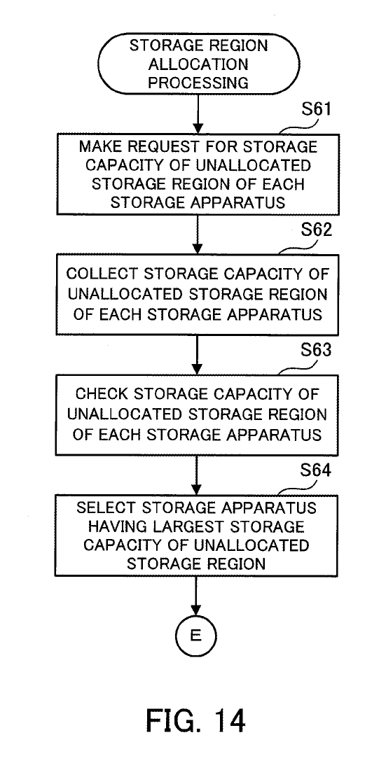

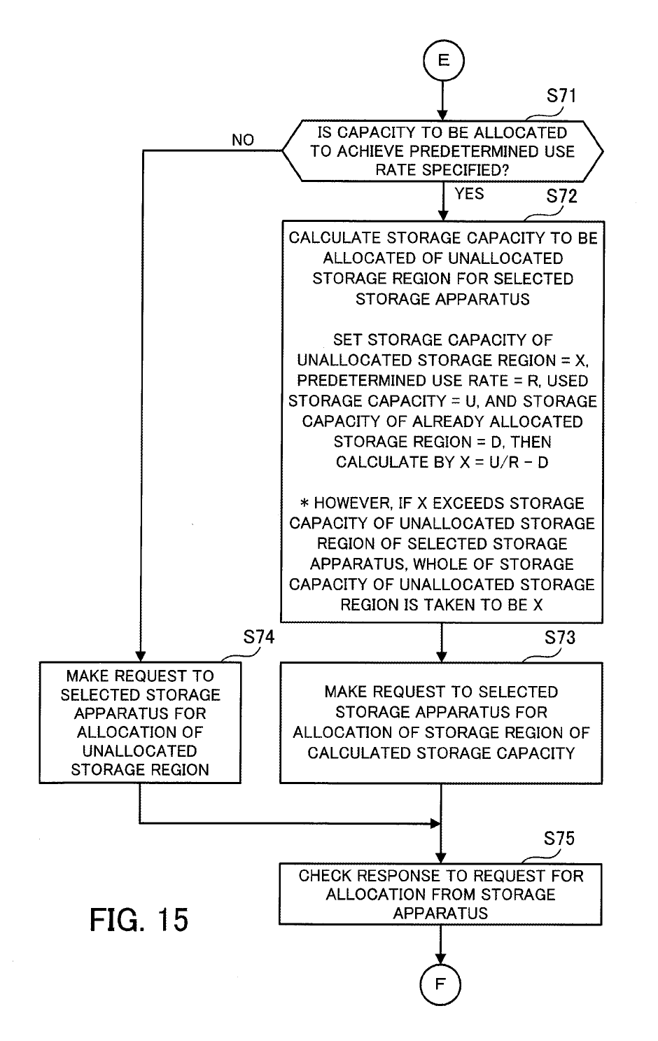

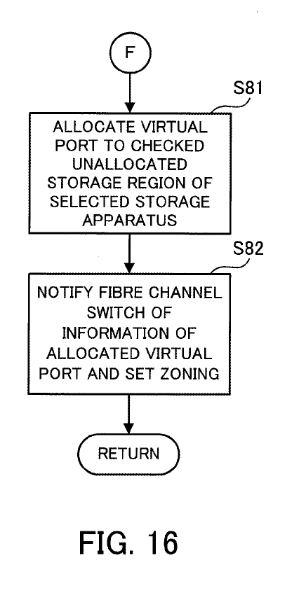

(Step S17) The server management controller 113 performs storage region allocation processing (to be described later in FIG. 14 to FIG. 16) to receive allocation of the disconnected storage region of the storage device (for example, storage device 310) of a new storage apparatus (for example, storage apparatus 300). After that, the processing is advanced to step S21.

(Step S21) The server management controller 113 changes the setting of the storage regions of the storage apparatuses 300 and 300a allocated to the server 100, changed at step S15 or at step S17, and performs re-recognition. After that, the processing is exited. When the storage capacity management processing is completed in the server 100, subsequently the allocation storage capacity management processing is started in the server 100a. After this, the allocation storage capacity management processing is performed sequentially in all the servers of the storage system.

Note that, although in the allocation storage capacity management processing of the present embodiment, after the amount of use of the storage region is acquired at step S11, the allocated storage capacity is acquired at step S12, this is not limited and it may also be possible to acquire the amount of use of the storage region after acquiring the allocated storage capacity.

FIG. 11 to FIG. 13 are a flowchart illustrating a procedure of storage region disconnection processing of the second embodiment. The storage region disconnection processing illustrated in FIG. 11 to FIG. 13 is a subroutine of the allocation storage capacity management processing described previously in FIG. 9 and FIG. 10. The servers 100 and 100a of the present embodiment call and execute the storage region disconnection processing at step S15 of the allocation storage capacity management processing. In the following, the storage region disconnection processing illustrated in FIG. 11 to FIG. 13 is explained in the order of step numbers of the flowchart.

(Step S31) The server management controller 113 makes a request to the storage apparatus (for example, storage apparatuses 300 and 300a) having the storage region connected to the server 100 for information indicative of the storage capacity of the allocated storage region of each storage apparatus. Here, the allocated storage region is a storage region of the storage region of the storage apparatus already allocated to one of the servers.

(Step S32) The server management controller 113 receives information indicative of the storage capacity of the allocated storage region, which is a response from the storage apparatuses 300 and 300a to the request at step S31, and collects the empty storage capacity of the allocated storage region of each storage apparatus.

(Step S33) The server management controller 113 checks the empty storage capacities of the allocated storage regions of the storage apparatuses 300 and 300a based on the information indicative of the empty storage capacities of the allocated storage regions of the storage apparatuses 300 and 300a collected at step S32.

(Step S34) The server management controller 113 selects the storage apparatus (for example, storage apparatus 300) having the largest empty storage capacity of the allocated storage region from among the storage apparatuses 300 and 300a checked at step S33. After that, the processing is advanced to step S41.

(Step S41) The server management controller 113 determines whether or not to specify storage capacity to achieve a predetermined use rate from the empty storage region of the allocated storage region of the storage apparatus selected at step S34. When specifying the storage capacity to achieve the predetermined use rate (step S41 YES), the processing is advanced to step S42. On the other hand, when not specifying the storage capacity to achieve the predetermined use rate (step S41 NO), the processing is advanced to step S44.

(Step S42) The server management controller 113 calculates storage capacity to be disconnected from the allocated storage region for the storage apparatus 300 selected at step S34. The storage capacity to be disconnected from the allocated storage region is calculated by dividing the amount of use by the predetermined use rate and subtracting the quotient from the storage capacity of all the allocated storage regions.

That is, if the storage capacity of the allocated storage region is taken to be Z, the predetermined use rate to be R, the used storage capacity to be U, and the capacity to be disconnected from the storage region to be Y, the capacity to be disconnected from the storage region is calculated by Y=Z−U/R.

However, if the calculated storage capacity exceeds the storage capacity of the empty storage region, the storage capacity of the empty storage region is taken to be a calculated storage capacity.

(Step S43) The server management controller 113 makes a request to the selected storage apparatus to disconnect the empty storage region of the storage capacity calculated at step S42.

(Step S44) The server management controller 113 makes a request to the storage apparatus 300 selected at step S34 to disconnect the empty storage region of the allocated storage region.

(Step S45) The server management controller 113 checks that the empty storage region of the allocated storage region has been disconnected by receiving a response to the request at step S43 or step S44 for disconnection of the empty storage region of the allocated storage region from the storage apparatus 300. After that, the processing is advanced to step S51.

(Step S51) The server management controller 113 checks the allocated storage region of the storage apparatus 300 selected at step S34.

(Step S52) The server management controller 113 determines whether or not the allocated storage region of the storage apparatus 300 checked at step S51 is zero. When the allocated storage region of the storage apparatus 300 is zero (step S52 YES), the processing is advanced to step S53. On the other hand, when the allocated storage region of the storage apparatus 300 is not zero (step S52 NO), the processing is returned to the start.

(Step S53) The server management controller 113 notifies the fibre channel switch 200 of the cancellation of zoning of the zone (for example, zone 2) by the virtual port to be used for the connection with the selected storage apparatus 300.

(Step S54) The server management controller 113 cancels the virtual port (for example, virtual port 3072) allocated to the storage apparatus 300 selected at step S34. When the virtual port (for example, virtual port 1072) of the server apparatus is not used for the connection with another virtual port, the virtual port of the server is also canceled. Due to this, the disconnected empty region becomes an unallocated storage region. After that, the processing is returned to the start.

FIG. 14 to FIG. 16 are a flowchart illustrating a procedure of storage region allocation processing of the second embodiment. The storage region allocation processing illustrated in FIG. 14 to FIG. 16 is a subroutine of the allocation storage capacity management processing described previously in FIG. 9 and FIG. 10. The servers 100 and 100a of the present embodiment call and execute the storage region allocation processing at step S17 of the allocation storage capacity management processing. In the following, the storage region allocation processing illustrated in FIG. 14 to FIG. 16 is explained in the order of step numbers of the flowchart.

(Step S61) The server management controller 113 makes a request to the storage apparatus (for example, storage apparatuses 300 and 300a) having the storage region connected to the server 100 for information indicative of the storage capacity of the unallocated storage region of each storage apparatus.

(Step S62) The server management controller 113 receives information indicative of the storage capacity of the unallocated storage region, which is a response to the request at step S61 from the storage apparatuses 300 and 300a, and collects the storage capacity of the unallocated storage region of each storage apparatus.

(Step S63) The server management controller 113 checks the storage capacities of the unallocated storage regions of the storage apparatuses 300 and 300a based on the information indicative of the storage capacities of the unallocated storage regions of the storage apparatuses 300 and 300a collected at step S62.

(Step S64) The server management controller 113 selects the storage apparatus (for example, storage apparatus 300) having the largest storage capacity of the unallocated storage region from among the storage apparatuses 300 and 300a checked at step S63. After that, the processing is advanced to step S71.

(Step S71) The server management controller 113 determines whether or not to specify a capacity to achieve a predetermined use rate from the unallocated storage region of the storage apparatus 300 selected at step S64. When specifying the storage capacity to achieve the predetermined use rate (step S71 YES), the processing is advanced to step S72. On the other hand, when not specifying the storage capacity to achieve the predetermined use rate (step S71 NO), the processing is advanced to step S74.

(Step S72) The server management controller 113 calculates a capacity to be allocated of the unallocated storage region for the storage apparatus 300 selected at step S64. The capacity to be allocated of the unallocated storage region is calculated by dividing the amount of use by the predetermined use rate and subtracting the storage capacity of the already allocated storage region from the quotient.

That is, if the storage capacity of the unallocated storage region is taken to be X, the predetermined use rate to be R, the used storage capacity to be U, and the storage capacity of the already allocated storage region to be D, the storage capacity of the unallocated storage region is calculated by X=U/R−D.

However, if the calculated storage capacity exceeds the unallocated storage region of the storage apparatus 300, the storage capacity of the unallocated storage region is taken to be a calculated storage capacity.

(Step S73) The server management controller 113 makes a request to the selected storage apparatus for the capacity to be allocated of the unallocated storage region calculated at step S72.

(Step S74) The server management controller 113 makes a request to the storage apparatus 300 selected at step S64 for allocation of an unallocated storage region.

(Step S75) The server management controller 113 checks that it is possible to allocate an unallocated storage region by receiving a response to the request at step S73 or step S74 for allocation of an unallocated storage region from the storage apparatus 300. After that, the processing is advanced to step S81.

(Step S81) The server management controller 113 allocates a virtual port (for example, virtual port 1072) to the unallocated storage region checked at step S75 of the storage apparatus 300 selected at step S64.

(Step S82) The server management controller 113 notifies the fibre channel switch 200 of the information indicative of the virtual port 1072 allocated at step S81 and performs setting of zoning of a zone (for example, zone 2) by the virtual port. After that, the processing is returned to the start.

Note that, the server management controller 113 of the present embodiment makes a request to the storage apparatus 300 having the largest unallocated storage region for allocation of an unallocated storage region to the server 100 in the storage region allocation processing. However, this is not limited, and it may also be possible for the server management controller 113 to make a request to the storage apparatus having the largest empty storage region allocated to another server at that point of time for disconnection of the server connected to the empty storage region and allocation of the empty storage region to the server 100 in the storage region allocation processing. Due to this, it is possible to increase the storage region of the server 100 without the need to wait for the completion of the storage region disconnection processing in another server.

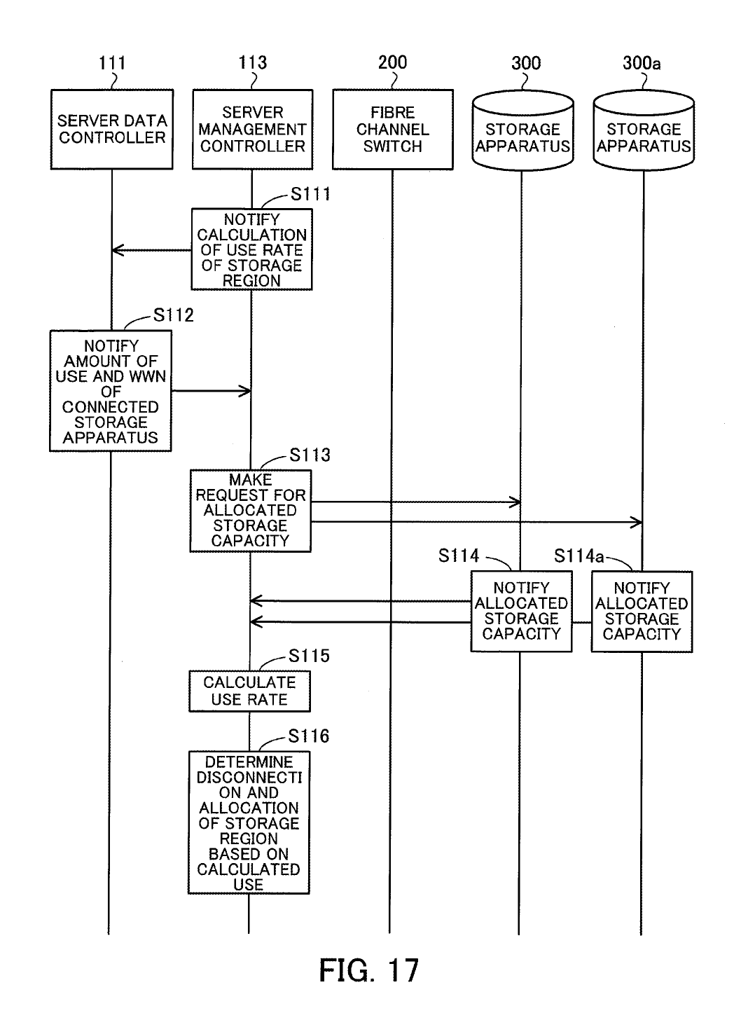

FIG. 17 is a sequence diagram illustrating a procedure of processing at the time of determination of disconnection of an empty region and allocation of an unallocated storage region performed in the storage system of the second embodiment. The server 100 of the present embodiment calculates a use rate of an allocated storage region and determines whether or not to perform disconnection of an empty region and allocation of an unallocated storage region based on the calculated use rate. In the following, with reference to FIG. 17, processing at the time of determination of disconnection of an empty region and allocation of an unallocated storage region performed in the server 100 of the present embodiment is explained.

(Step S111) The server management controller 113 notifies the server data controller 111 of calculation of a use rate.

(Step S112) Upon receipt of the notification of calculation of a use rate notified at step S111, the server data controller 111 notifies the server management controller 113 of an amount of use of the storage of the server 100 and the WWN of the connected storage apparatus (for example, storage apparatuses 300 and 300a).

(Step S113) The server management controller 113 makes a request to the storage apparatuses 300 and 300a for information indicative of the storage capacity of the storage region allocated to the server 100 based on the WWN of the connected storage apparatuses 300 and 300a notified at step S112.

(Step S114) Upon receipt of the request for the information indicative of the storage capacity of the storage region of the storage apparatus 300 allocated to the server 100 made at step S113, the storage apparatus 300 notifies the server management controller 113 of the storage capacity of the storage region of the storage device 310 of the storage apparatus 300 allocated to the server 100.

(Step S114a) Upon receipt of the request for the information indicative of the storage capacity of the storage region of the storage apparatus 300a allocated to the server 100 made at step S113, the storage apparatus 300a notifies the server management controller 113 of the storage capacity of the storage region of the storage device 310a of the storage apparatus 300a allocated to the server 100.

(Step S115) The server management controller 113 calculates a use rate based on the storage capacity of the storage region allocated to the server 100 and the amount of use of the storage acquired at step S112.

(Step S116) The server management controller 113 determines whether or not to perform disconnection of an empty region and allocation of an unallocated storage region based on the use rate calculated at step S115.

As described previously in FIG. 9 and FIG. 10, when the use rate is equal to or more than the predetermined upper limit value as the result of the determination at step S116, an unallocated storage region is allocated to the server 100. Further, when the use rate is less than the predetermined lower limit value, the empty region allocated to the server 100 is disconnected. Furthermore, when the use rate is less than the predetermined upper limit value and also equal to or more than the predetermined lower limit value, neither allocation nor disconnection is performed.

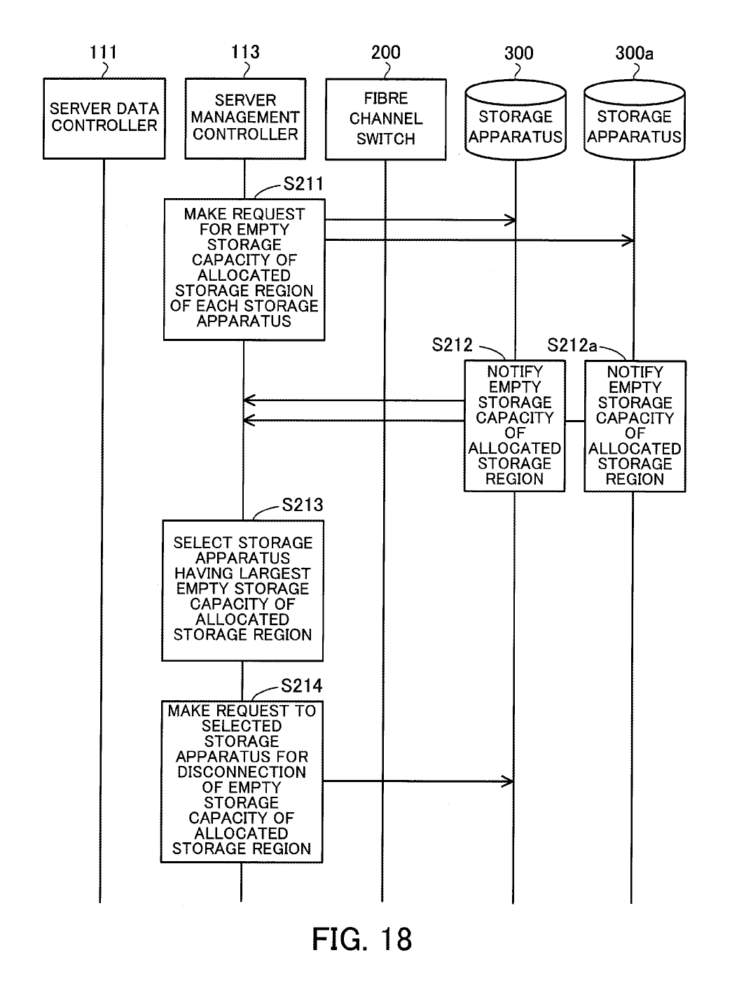

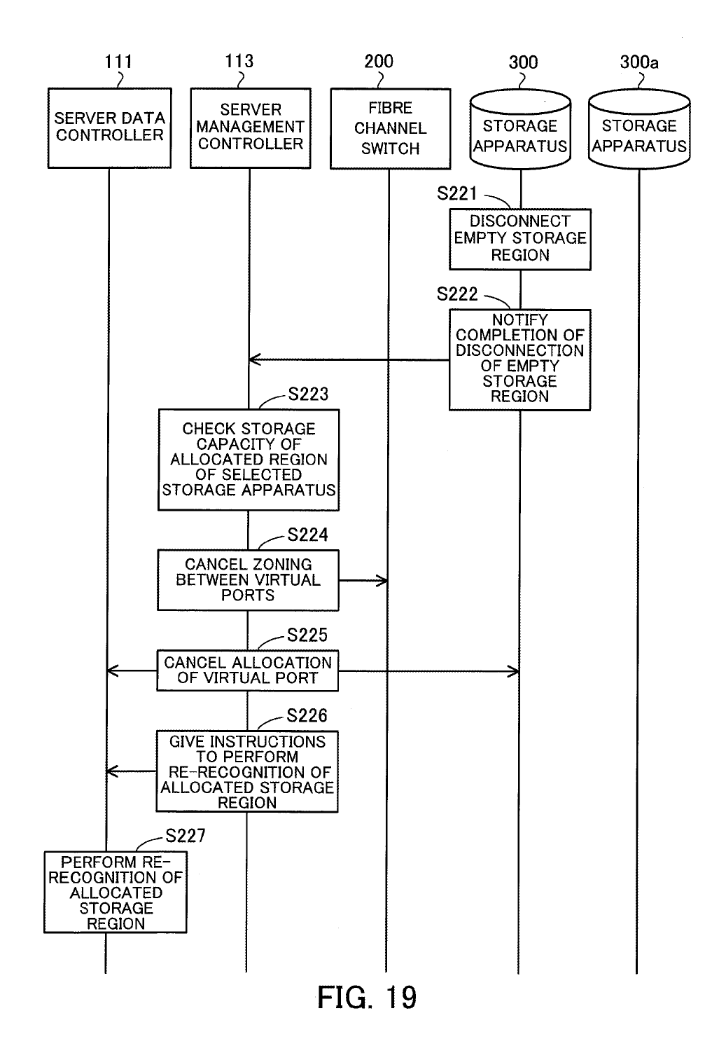

FIG. 18 and FIG. 19 are a sequence diagram illustrating a procedure of processing at the time of disconnection of an empty region performed in the storage system of the second embodiment. In the server 100 of the present embodiment, when it is determined that disconnection of an empty region is performed based on the calculated use rate, the empty region allocated to the server 100 is disconnected. In the following, with reference to FIG. 18 and FIG. 19, processing at the time of disconnection of an empty region performed in the server 100 of the present embodiment is explained.

(Step S211) The server management controller 113 makes a request to the storage apparatus (for example, storage apparatuses 300, 300a) connected to the server 100 for information indicative of the empty storage capacity of the allocated storage region of each storage apparatus.

(Step S212) Upon receipt of the request for information indicative of the empty storage capacity of the allocated storage region made at step S211, the storage apparatus 300 notifies the server management controller 113 of the empty storage capacity of the allocated storage region of the storage device 310 of the storage apparatus 300.

(Step S212a) Upon receipt of the request for information indicative of the empty storage capacity of the allocated storage region made at step S211, the storage apparatus 300a notifies the server management controller 113 of the empty storage capacity of the allocated storage region of the storage device 310a of the storage apparatus 300a.

(Step S213) The server management controller 113 selects the storage apparatus (for example, storage apparatus 300) having the largest empty storage capacity of the allocated storage region based on the empty storage capacities of the allocated storage regions of the storage apparatuses 300 and 300a notified at steps S212 and S211a.

(Step S214) The server management controller 113 makes a request to the storage apparatus 300 selected at step S213 to disconnect the empty storage region of the allocated storage region. When specifying the capacity of the empty storage region to achieve the predetermined use rate, the server management controller 113 make a request for disconnection of the allocated storage region of the capacity.

(Step S221) Upon receipt of the request to disconnect the empty storage region of the allocated storage region made at step S214, the storage apparatus 300 disconnects the empty storage region of the storage region allocated to the server 100.

(Step S222) When disconnection of the empty storage region of the storage region allocated to the server 100 is completed, the storage apparatus 300 notifies the server management controller 113 of completion of disconnection of the empty storage region. Due to this, the disconnected empty region becomes an unallocated storage region.

(Step S223) The server management controller 113 checks the capacity of the allocated storage region of the storage apparatus 300 selected at step S213. When the allocated storage region capacity of the server 100 is zero, the processing is advanced to step S224. When the allocated storage region capacity of the server 100 is not zero, the processing is advanced to step S226.

(Step S224) The server management controller 113 notifies the fibre channel switch 200 of cancellation of zoning between the virtual ports used to connect the server 100 and the allocated storage region of the storage apparatus 300 selected at step S213.

(Step S225) The server management controller 113 gives instructions to the server data controller 111 and the storage apparatus 300 to cancel the virtual ports used to connect the server 100 and the allocated storage region of the storage apparatus 300 selected at step S213.

(Step S226) The server management controller 113 gives instructions to the server data controller 111 to perform re-recognition of the storage region allocated to the server 100.

(Step S227) Upon receipt of the instructions to perform re-recognition of the storage region allocated to the server 100 given at step S226, the server data controller 111 performs re-recognition of the storage region of the storage apparatus (for example, storage region of the storage device 310 of the storage apparatus 300 and storage region of the storage device 310a of the storage apparatus 300a) allocated to the server 100. Due to this, the unallocated storage region disconnected at step S222 is canceled by the server data controller 111 and allocation is enabled from all the servers.

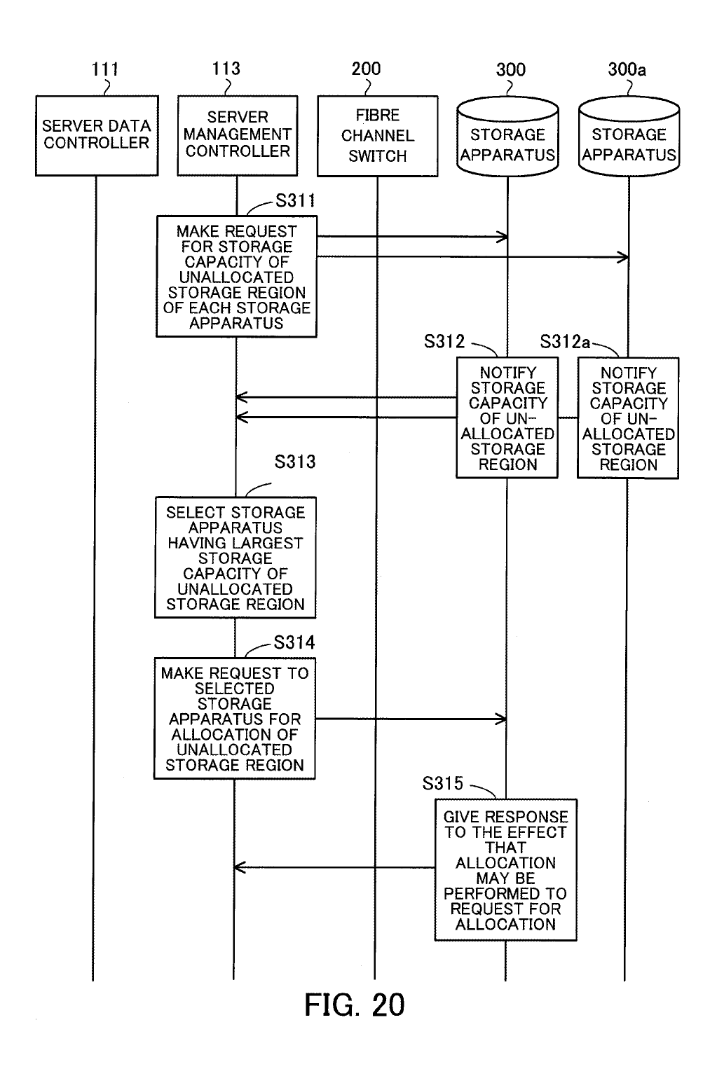

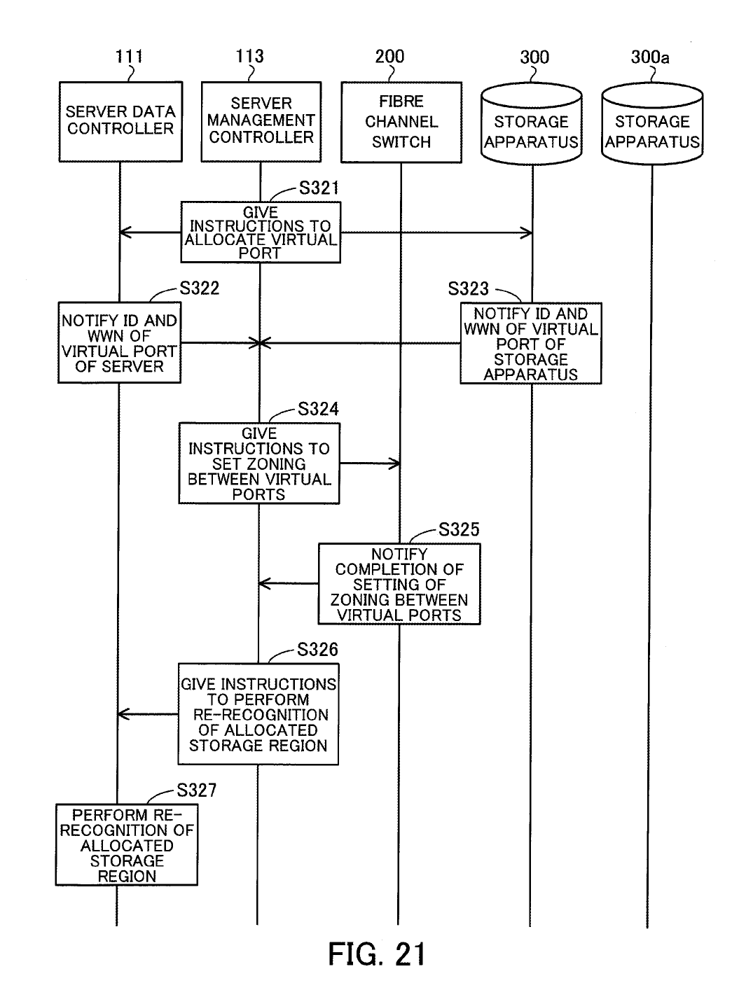

FIG. 20 and FIG. 21 are a sequence diagram illustrating a procedure of processing at the time of allocation of an unallocated storage region performed in the storage system of the second embodiment. In the server 100 of the present embodiment, when it is determined that allocation of an unallocated storage region is performed based on the calculated use rate, an unallocated storage region is allocated to the server 100. In the following, with reference to FIG. 20 and FIG. 21, processing at the time of allocation of an unallocated storage region performed in the server 100 of the present embodiment is explained.

(Step S311) The server management controller 113 makes a request to the storage apparatus (for example, storage apparatuses 300 and 300a) connected to the server 100 for information indicative of the storage capacity of the unallocated storage region of each storage apparatus.

(Step S312) Upon receipt of the request for information indicative of the storage capacity of the unallocated storage region made at step S311, the storage apparatus 300 notifies the server management controller 113 of the storage capacity of the disconnected storage region of the storage device 310 of the storage apparatus 300.

(Step S312a) Upon receipt of the request for information indicative of the storage capacity of the unallocated storage region made at step S311, the storage apparatus 300a notifies the server management controller 113 of the storage capacity of the unallocated storage region of the storage device 310a of the storage apparatus 300a.

(Step S313) The server management controller 113 selects the storage apparatus (for example, storage apparatus 300) having the largest disconnected empty capacity based on the storage capacities of the unallocated storage regions of the storage apparatuses 300 and 300a notified at steps S312 and S312a.

(Step S314) The server management controller 113 makes a request to the storage apparatus 300 selected at step S313 for allocation of the unallocated storage region. When specifying the capacity of the storage region to achieve the predetermined use rate, the server management controller 113 makes a request for allocation of the unallocated storage region of the capacity.

(Step S315) Upon receipt of the request for allocation of the unallocated storage region made at step S314, the storage apparatus 300 gives a response to the effect that it is possible to allocate the unallocated storage region to the server 100 if it is possible to allocate the unallocated storage region to the server 100.

(Step S321) Upon receipt of the response to the effect that it is possible to allocate the unallocated storage region given at step S315, the server management controller 113 gives instructions to the server data controller 111 and the storage apparatus 300 to allocate virtual ports.

(Step S322) Upon receipt of the instructions to allocate a virtual port given at step S321, the server data controller 111 sets a virtual port in the server 100 and notifies the server management controller 113 of Server Virtual Port ID and Server Virtual Port WWN of the set virtual port.

(Step S323) Upon receipt of the instructions to allocate a virtual port given at step S321, the storage apparatus 300 sets a virtual port in the storage apparatus 300 and notifies the server management controller 113 of Storage Virtual Port ID and Storage Virtual Port WWN of the set virtual port.

(Step S324) When acquiring Server Virtual Port ID and Server Virtual Port WWN notified at step S322 and Storage Virtual Port ID and Storage Virtual Port WWN notified at step S323, the server management controller 113 gives instructions to the fibre channel switch 200 to set zoning between the set virtual ports of the server 100 and the storage apparatus 300.

(Step S325) Upon receipt of the instructions at step 324 to set zoning between the virtual ports, the fibre channel switch 200 sets zoning between the virtual ports of the server 100 and the storage apparatus 300 in the fibre channel switch 200 and notifies the server management controller 113 of completion of the setting of zoning.

(Step S326) The server management controller 113 gives instructions to the server data controller 111 to perform re-recognition of the storage region allocated to the server 100.

(Step S327) Upon receipt of the instructions to perform re-recognition of the storage region allocated to the server 100 given at step S326, the server data controller 111 performs re-recognition of the storage region of the storage apparatus (for example, storage region of the storage device 310 of the storage apparatus 300 and storage region of the storage device 310a of the storage apparatus 300a) allocated to the server 100.

As described above, in the server 100 of the second embodiment, the server management controller 113 calculates the use rate based on the storage capacity of the allocated storage region of the storage apparatus 300 and the amount of use of the storage region, and determines whether or not to perform allocation based on the calculated use rate. When determining to perform allocation, the server management controller 113 allocates the unallocated storage region of the storage apparatus 300 to the server 100, and also sets a virtual port at the fibre channel physical port 112 and connects the server 100 to the unallocated storage region of the storage apparatus 300 allocated by the set virtual port. Due to this, in the case where the storage capacity allocated to the server 100 runs short, it is made possible to easily change arrangement of storage resources of each apparatus of the storage system without the need to newly provide a storage apparatus and without the need to stop the communication operation of each apparatus of the storage system.

Further, the server management controller 113 determines whether or not to perform disconnection based on the calculated use rate and when determining to perform disconnection, the server management controller 113 disconnects part or the whole of the empty region in the storage region allocated to the server 100 in a state capable of being allocated to another server to produce an unallocated storage region. Due to this, in the case where the storage capacity allocated to the server 100 is in surplus, the surplus storage region is released in a state capable of being used by another server, and therefore, it is made possible to easily change arrangement of storage resources of each apparatus of the storage system without the need to newly provide a storage apparatus and without the need to stop the communication operation of each apparatus of the storage system.

Further, when determining to perform allocation, the server management controller 113 makes a request to each storage apparatus of the storage system to disconnect part or the whole of the empty region in the storage region allocated to another server in a state capable of being allocated to the server 100 to produce an unallocated storage region and allocates the unallocated storage region to the server 100, and also sets a virtual port and connects the server 100 to the unallocated storage region allocated by the set virtual port. Due to this, in the case where the storage capacity allocated to the server 100 runs short, it is possible to make a request to disconnect the empty region not disconnected yet in another server to produce an unallocated storage region, and therefore, it is made possible to easily change arrangement of storage resources of each apparatus of the storage system.

Further, when determining to perform allocation, the server management controller 113 makes a request to each storage apparatus of the storage system for control information having information indicative of the amount of the unallocated storage region of each storage apparatus, and determines the storage apparatus having the largest unallocated storage region based on the control information. Due to this, it is possible to increase the use efficiency of the storage region in the storage system by receiving allocation of the storage region from the storage apparatus whose storage region is used least.

Further, when determining to perform allocation, the server management controller 113 makes a request to the storage apparatus having the unallocated storage region to be allocated to the server 100 for control information having information indicative of the virtual port that the storage apparatus sets, and connects the server 100 to the unallocated storage region that is allocated by connecting the virtual port set on the server 100 side and the virtual port set on the storage apparatus side based on the control information. Due to this, it is made possible to set a zone by the virtual ports between the server 100 and the allocated storage region based on the control information transmitted from the storage apparatus.

In addition, the server management controller 113 performs transmission and reception of information with the storage apparatus having the allocated storage region via the LAN port 114. Due to this, in the case where data communication is performed by the fibre channel 600 in the storage system and control information is transmitted and received by the LAN 500, control of allocation and disconnection is performed.

### Third Embodiment

Next, a third embodiment is explained. Different points from the second embodiment described above are explained mainly and the same symbols are used for the same items and explanation thereof is omitted.

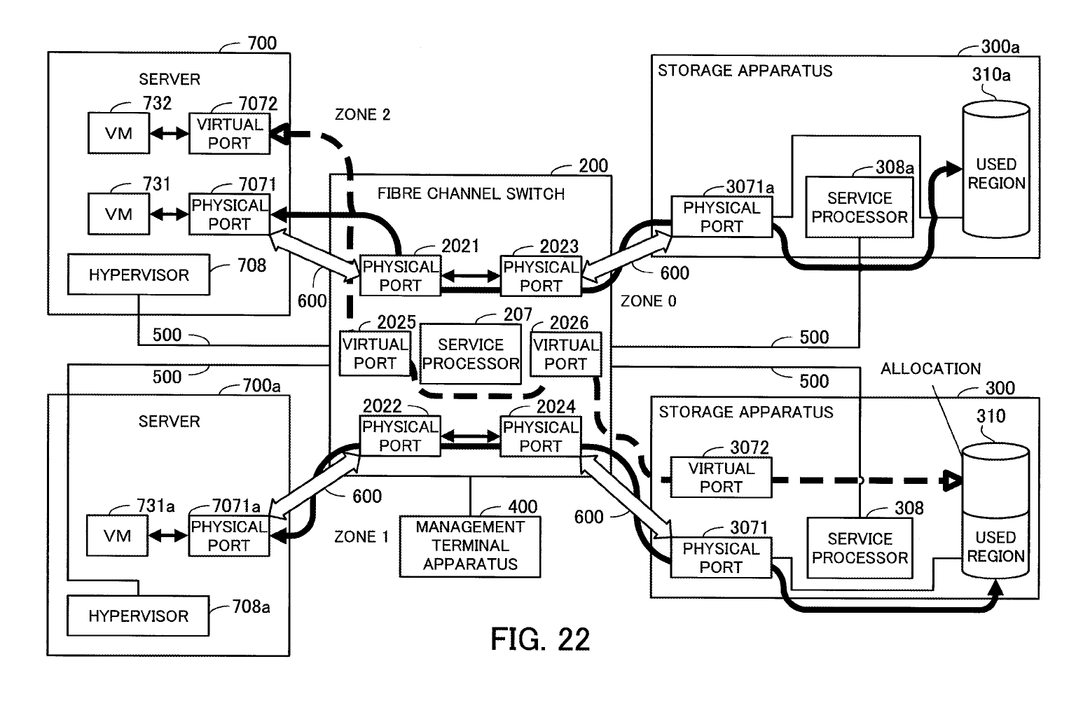

FIG. 22 illustrates connections between servers and storage regions of storage apparatuses by physical ports and virtual ports of the third embodiment. As illustrated in FIG. 22, a storage system of the present embodiment has servers 700 and 700a, the fibre channel switch 200, the storage apparatuses 300 and 300a, and the management terminal apparatus 400.

In the present embodiment, on the server 700, virtual machines (VM) 731 and 732 operate and also on the server 700a, a virtual machine 731a operates. Here, in the virtual machines (for example, virtual machines 731 and 732) operating on the same server (for example, server 700), ports (physical port and virtual port) used for communication and storage regions of the storage apparatuses 300 and 300a to be used are set individually and it is not possible for each of the virtual machines to mutually use the port or the storage region of another virtual machine. That is, it is not possible for each of the virtual machines to acquire data transmitted and received by the port of another virtual machine or data in the storage region allocated to another virtual machine. This also applies to other servers and virtual machines operating on other servers.

In the present embodiment, each of the virtual machines 731, 732, and 731a has the function of the server data controller 111 of the second embodiment and performs the allocation storage capacity management processing described previously in FIG. 9 and FIG. 10, the storage region disconnection processing described previously in FIG. 11 to FIG. 13, and the storage region allocation processing described previously in FIG. 14 to FIG. 16, and performs transmission and reception of data with the storage regions of the storage apparatuses 300 and 300a.

Further, in the present embodiment, hypervisors 708 and 708a operate on the servers 700 and 700a, respectively, and cause the virtual machines 731, 732, and 731a to operate and also, as with the service processors 108 and 108a of the second embodiment, control connections between the virtual machines 731, 732, and 731a and the storage apparatuses 300 and 300a. The hypervisors 708 and 708a have the function of the server management controller 113 of the second embodiment. The hypervisor 708 controls disconnection and allocation of the storage regions of the storage apparatuses 300 and 300a for the virtual machines 731 and 732. The hypervisor 708a controls disconnection and allocation of the storage regions of the storage apparatuses 300 and 300a for the virtual machine 731a.

The server 700 has a physical port 7071 and the hypervisor 708. In the server 700, a virtual port 7072 is set. The hypervisor 708 is a control program to construct the virtual machines 731 and 732 on the server 700 and also to perform control of the virtual machines 731 and 732 and the storage system. Further, it is possible for the hypervisor 708 to cause the OS to operate individually on the virtual machines 731 and 732. The hypervisor 708 may operate directly on the hardware of the server 100 or may operate on the OS of the server 100. The server 700a has a physical port 7071a and the hypervisor 708a. It is possible for each of the servers 700 and 700a to operate a plurality of virtual machines.

The hypervisor 708 calculates a use rate based on the storage capacities of the storage regions of the storage apparatuses 300 and 300a allocated to the virtual machines 731 and 732 and the amounts of use of the storage regions, and determines whether or not to perform allocation and disconnection based on the calculated use rate.

For example, when determining to perform allocation for the virtual machine 732, the hypervisor 708 allocates an unallocated storage region allocated to none of servers and virtual machines to the virtual machine 732, and also sets the virtual port 7072 and connects the virtual machine 732 to the unallocated storage region of the storage apparatus 300 that is allocated by the set virtual port 7072.

The virtual machine 731 performs transmission and reception of data by the zone 0 with the storage apparatus 300a having the storage region allocated to the virtual machine 731 by the physical port 7071. The virtual machine 732 performs transmission and reception of data by the zone 2 with the storage apparatus 300 having the storage region allocated to the virtual machine 732 by the virtual port 7072.

The fibre channel switch 200 has the physical ports 2021, 2022, 2023, and 2024, and the service processor 207. Further, in the fibre channel switch 200, the virtual ports 2025 and 2026 are set.

The storage apparatus 300 has the physical port 3071, the service processor 308 configured to control the storage apparatus 300 and the storage system, and the storage device 310. In the storage apparatus 300, the virtual port 3072 is set. The storage apparatus 300a has the physical port 3071a, the service processor 308a configured to control the storage apparatus 300a and the storage system, and the storage device 310a.

The physical port 7071 is connected to the physical port 2021 by the fibre channel 600. The physical port 7071a is connected to the physical port 2022 by the fibre channel 600. The physical port 3071 is connected to the physical port 2024 by the fibre channel 600. The physical port 3071a is connected to the physical port 2023 by the fibre channel 600. The hypervisors 708 and 708a, the service processors 207, 308, and 308a, and the management terminal apparatus 400 are connected by the LAN 500.

In addition, it is assumed that the server 700 is connected to the storage device 310a of the storage apparatus 300a via the physical ports 2021 and 2023 of the fibre channel switch 200 and the physical port 3071a of the storage apparatus 300a by the physical port 7071 and the zone 0 is set as illustrated in FIG. 22. It is also assumed that: the full storage region of the storage device 310a is allocated to the server 700; the server 700a is connected to the storage device 310 of the storage apparatus 300 via the physical ports 2022 and 2024 of the fibre channel switch 200 and the physical port 3071 of the storage apparatus 300 by the physical port 7071a and the zone 1 is set; and the server 700 is connected to the unallocated storage region of the storage device 310 of the storage apparatus 300 via the virtual ports 2025 and 2026 of the fibre channel switch 200 and the virtual port 3072 of the storage apparatus 300 by the virtual port 7072 and the zone 2 is set.

In the following, the operation of the storage system of the present embodiment is explained. Here, it is assumed that the hypervisors 708 and 708a, and the service processors 207, 308, and 308a have acquired control information indicative of the state of each apparatus of the storage system in advance.

First, the hypervisors 708 and 708a check the use situation of the storage regions of the storage apparatuses 300 and 300a in each of the virtual machines 731, 732, and 731a.

Next, it is assumed that the hypervisor 708 has added the virtual machine 732 to the server 700. Here, when the unallocated storage region that may be allocated to the server 700 does not exist or runs short, the hypervisor 708 makes a request to the service processor (for example, service processor 308) of the storage apparatus (for example, storage apparatus 300) in which the amount of use of the storage region is 50% or less for disconnection of the empty storage region.

Upon receipt of the request for disconnection, the service processor 308 disconnects 50% of the empty storage region from the server (for example, server 700a) to which the storage region is allocated to produce an unallocated storage region and sets the virtual port 3072.

The hypervisor 708 sets the virtual port 7072 to be connected to the unallocated storage region of the storage apparatus 300 in a state capable of being used by the virtual machine 732, and transmits control information having information of the set virtual port 7072 to the service processor 207.

Upon receipt of the transmitted control information, the service processor 207 sets the virtual ports 2025 and 2026, performs zoning of the virtual ports 7072, 2025, 2026, and 3072, and sets the zone 2.

Next, the hypervisor 708 transmits instructions to the virtual machine 732 to recognize the storage region of the storage apparatus 300 allocated to the virtual machine 732. Due to this, it is made possible for the virtual machine 732 to use the allocated storage region.

As described above, in the server 700 of the third embodiment, the hypervisor 708 calculates the use rate based on the storage capacity of the allocated storage region of the storage apparatus 300 and the amount of use of the storage region and determines whether or not to perform allocation based on the calculated use rate. When determining to perform allocation, the hypervisor 708 allocates the unallocated storage region of the storage apparatus 300 to the virtual machine 732, and also sets the virtual port 7072 and connects the virtual machine 732 to the unallocated storage region of the storage apparatus 300 allocated by the set virtual port 7072. Due to this, in the case where the storage capacity allocated to the virtual machine 732 runs short, it is made possible to easily change arrangement of storage resources of each apparatus of the storage system without the need to newly provide a storage apparatus and without the need to stop the communication operation of each apparatus of the storage system.

### Fourth Embodiment

Next, a fourth embodiment is explained. Different points from the second embodiment described above are explained mainly and the same symbols are used for the same items and also explanation thereof is omitted.

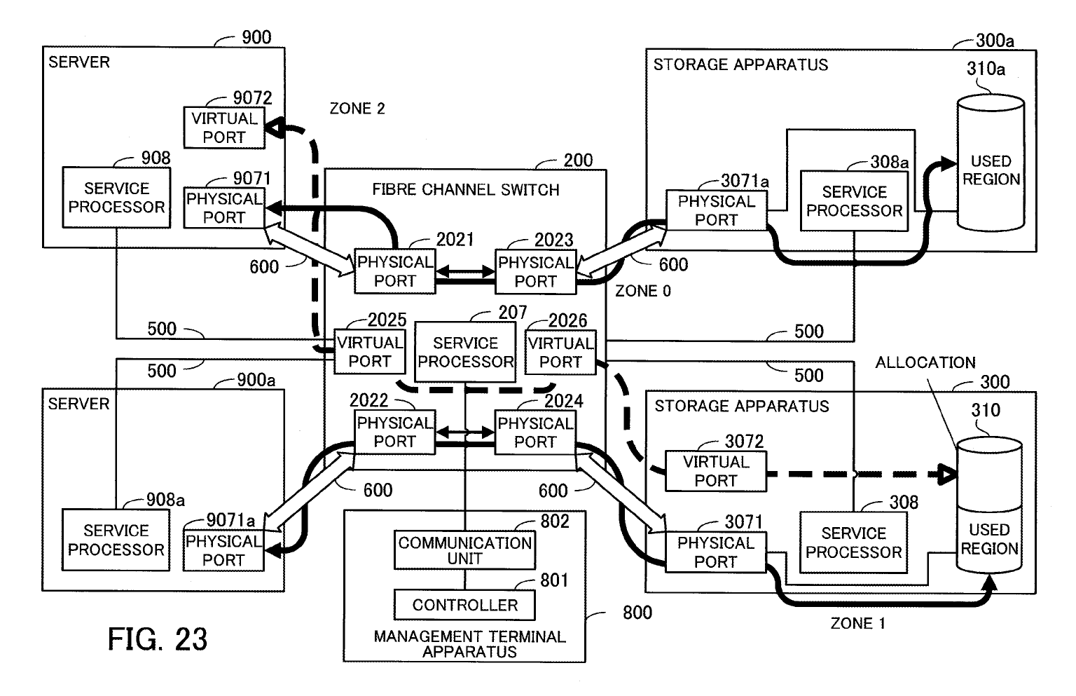

FIG. 23 illustrates connections between servers and storage regions of storage apparatuses by physical ports and virtual ports of the fourth embodiment. As illustrated in FIG. 23, a storage system of the present embodiment has servers 900 and 900a, the fibre channel switch 200, the storage apparatuses 300 and 300a, and a management terminal apparatus 800.

In the present embodiment, the management terminal apparatus 800 has a controller 801 and a communication unit 802. The controller 801 has the function of the server management controller 113 of the second embodiment and performs the allocation storage capacity management processing described previously in FIG. 9 and FIG. 10, the storage region disconnection processing described previously in FIG. 11 to FIG. 13, and the storage region allocation processing described previously in FIG. 14 to FIG. 16, and controls disconnection and allocation of the storage regions of the storage apparatuses 300 and 300a for the servers 900 and 900a.

The server 900 has a physical port 9071 and a service processor 908. In the server 900, a virtual port 9072 is set based on control of the controller 801. The service processor 908 receives allocation of the unallocated storage region of the storage apparatus 300 for the server 900 based on the control of the controller 801 by performing transmission and reception of control information via the LAN 500 by a LAN port, not illustrated, connected to the service processor 908 and the communication unit 802. The server 900a has a physical port 9071a and a service processor 908a.

The fibre channel switch 200 has the physical ports 2021, 2022, 2023, and 2024, and the service processor 207. In the fibre channel switch 200, the virtual ports 2025 and 2026 are set.

The storage apparatus 300 has the physical port 3071, the service processor 308 configured to control the storage apparatus 300 and the storage system, and the storage device 310. In the storage apparatus 300, the virtual port 3072 is set. The storage apparatus 300a has the physical port 3071a, the service processor 308a configured to control the storage apparatus 300a and the storage system, and the storage device 310a.

The physical port 9071 is connected to the physical port 2021 by the fibre channel 600. The physical port 9071a is connected to the physical port 2022 by the fibre channel 600. The physical port 3071 is connected to the physical port 2024 by the fibre channel 600. The physical port 3071a is connected to the physical port 2023 by the fibre channel 600. The service processors 908 and 908a, the service processors 207, 308, and 308a, and the communication unit 802 are connected by the LAN 500.

In addition, it is assumed that the server 900 is connected to the storage device 310a of the storage apparatus 300a via the physical ports 2021 and 2023 of the fibre channel switch 200 and the physical port 3071a of the storage apparatus 300a by the physical port 9071 and the zone 0 is set as illustrated in FIG. 23. It is also assumed that: the full storage region of the storage device 310a is allocated to the server 900; and the server 900a is connected to the storage device 310 of the storage apparatus 300 via the physical ports 2022 and 2024 of the fibre channel switch 200 and the physical port 3071 of the storage apparatus 300 by the physical port 9071a and the zone 1 is set.

As with the server management controller 113 of the second embodiment, the controller 801 calculates a use rate based on the storage capacities of the storage regions of the storage apparatuses 300 and 300a allocated to the servers 900 and 900a and the amounts of use of the storage regions, and determines whether or not to perform allocation and disconnection for the servers 900 and 900a based on the calculated use rate.

For example, when determining to perform allocation for the server 900, the controller 801 allocates an unallocated storage region of the storage apparatus 300 allocated to none of the servers 900 and 900a to the server 900, and also sets the virtual ports 9072, 2025, 2026, and 3072 and performs control to connect the server 900 and the unallocated storage region of the storage apparatus 300 that is allocated by the set virtual ports 9072, 2025, 2026, and 3072.

It is assumed that by the control of the controller 801 described above, the server 900 is connected to the unallocated storage region of the storage device 310 of the storage apparatus 300 via the virtual ports 2025 and 2026 of the fibre channel switch 200 and the virtual port 3072 of the storage apparatus 300 by the virtual port 9072 and the zone 2 is set.

In the following, the operation of the storage system of the present embodiment is explained. Here, it is assumed that the controller 801 has acquired control information indicative of the state of each apparatus of the storage system in advance.

First, the controller 801 checks the use situation of the storage regions of the storage apparatuses 300 and 300a in the servers 900 and 900a.

Here, when the management terminal apparatus 800 receives instructions to change the capacity from an administrator or when the margin of the storage region runs short in the server 900, if the unallocated storage region that may be allocated does not exist or runs short, the controller 801 makes a request to the service processor (for example, service processor 308) of the storage apparatus (for example, storage apparatus 300) in which the amount of use of the storage region is 50% or less for disconnection of the empty storage region.

Upon receipt of the request for disconnection, the service processor 308 disconnects 50% of the empty storage region from the server (for example, server 900a) to which the storage region is allocated to produce an unallocated storage region and sets the virtual port 3072.

The controller 801 causes the service processor 908 to set the virtual port 9072 to be connected to the unallocated storage region of the storage apparatus 300 in a state capable of being used by the server 900, and also causes the service processor 908 to transmit control information having information of the set virtual port 9072 to the service processor 207.

Upon receipt of the transmitted control information, the service processor 207 sets the virtual ports 2025 and 2026, performs zoning of the virtual ports 9072, 2025, 2026, and 3072, and sets the zone 2.

Next, the controller 801 transmits instructions to recognize the storage region of the storage apparatus 300 allocated to the server 900 to the server 900. Due to this, it is made possible for the server 900 to use the allocated storage region.

As described above, in the management terminal apparatus 800 of the fourth embodiment, the controller 801 calculates the use rate based on the storage capacities of the storage regions of the storage apparatuses 300 and 300a allocated to the servers 900 and 900a and the amounts of use of the storage regions, and determines whether or not to perform allocation and disconnection based on the calculated use rate. When determining to perform allocation, the controller 801 allocates the unallocated storage region to the server 900, and also sets the virtual port and performs control to connect the server 900 and the unallocated storage region that is allocated by the set virtual port. Due to this, using the management terminal apparatus 800, in the case where the storage capacity allocated to the server 900 runs short, it is made possible to easily change arrangement of storage resources of each apparatus of the storage system without the need to newly provide a storage apparatus and without the need to stop the communication operation of each apparatus of the storage system.

### Fifth Embodiment

Next, a fifth embodiment is explained. Different points from the second embodiment described above are explained mainly and the same symbols are used for the same items and explanation thereof is omitted.

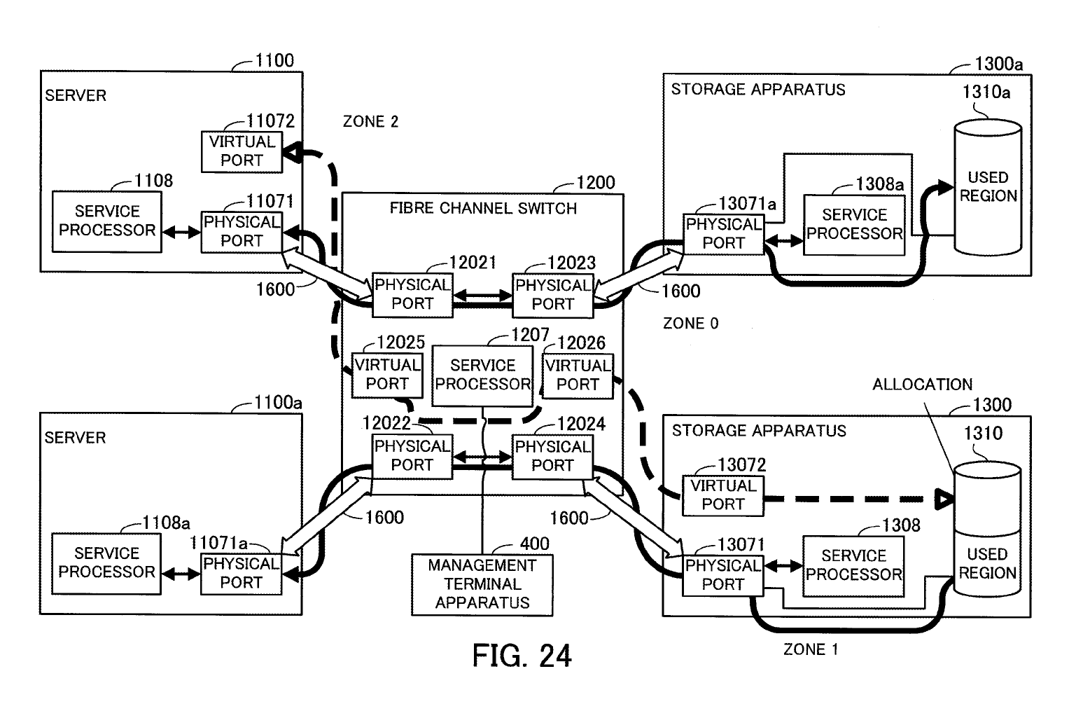

FIG. 24 illustrates connections between servers and storage regions of storage apparatuses by physical ports and virtual ports of the fifth embodiment. As illustrated in FIG. 24, a storage system of the present embodiment has servers 1100 and 1100a, a CEE (Converged Enhanced Ethernet) switch 1200, storage apparatuses 1300 and 1300a, and the management terminal apparatus 400.

In the present embodiment, a CEE 1600 connecting the servers 1100 and 1100a, the CEE switch 1200, and the storage apparatuses 1300 and 1300a is a CEE capable of LAN communication and fibre channel communication by one physical port. Fibre channel communication by the CEE uses the FCoE (Fibre Channel over Ethernet) protocol and performs transmission and reception of fibre channel data. Due to this, between each apparatus of the storage system, it is possible to transmit and receive data and control signals by the CEE 1600. Service processors 1108 and 1108a have the function of the server management controller 113 of the second embodiment and perform the allocation storage capacity management processing described previously in FIG. 9 and FIG. 10, the storage region disconnection processing described previously in FIG. 11 to FIG. 13, and the storage region allocation processing described previously in FIG. 14 to FIG. 16 and control disconnection and allocation of the storage regions of the storage apparatuses 1300 and 1300a for the servers 1100 and 1100a.

The server 1100 has a physical port 11071 and the service processor 1108. In the server 1100, a virtual port 11072 is set. The service processor 1108 controls allocation of the unallocated storage region of the storage apparatus 1300 for the server 1100 by performing transmission and reception of control information with another apparatus of the storage system via the CEE 1600 by the physical port 11071 connected to the service processor 1108. The server 1100a has a physical port 11071a and the service processor 1108a.

The CEE switch 1200 has physical ports 12021, 12022, 12023, and 12024, and a service processor 1207. In the CEE switch 1200, virtual ports 12025 and 12026 are set.

The storage apparatus 1300 has a physical port 13071, a service processor 1308 configured to perform control of the storage apparatus 1300 and the storage system, and a storage device 1310. In the storage apparatus 1300, a virtual port 13072 is set. The storage apparatus 1300a has a physical port 13071a, a service processor 1308a configured to perform control of the storage apparatus 1300a and the storage system, and a storage device 1310a.

The physical port 11071 is connected to the physical port 12021 by the CEE 1600. The physical port 11071a is connected to the physical port 12022 by the CEE 1600. The physical port 13071 is connected to the physical port 12024 by the CEE 1600. The physical port 13071a is connected to the physical port 12023 by the CEE 1600. The service processors 1108, 1108a, 1207, 1308, and 1308a are connected by the CEE 1600 via the physical ports 11071, 11071a, 12021, 12022, 12023, 12024, 13071, and 13071a.

In addition, it is assumed that the server 1100 is connected to the storage device 1310a of the storage apparatus 1300a via the physical ports 12021 and 12023 of the CEE switch 1200 and the physical port 13071a of the storage apparatus 1300a by the physical port 11071 and the zone 0 is set as illustrated in FIG. 24. It is also assumed that: the full storage region of the storage device 1310a is allocated to the server 1100; and the server 1100a is connected to the storage device 1310 of the storage apparatus 1300 via the physical ports 12022 and 12024 of the CEE switch 1200 and the physical port 13071 of the storage apparatus 1300 by the physical port 11071a and the zone 1 is set.

It is assumed that the server 1100 is connected to the unallocated storage region of the storage device 1310 of the storage apparatus 1300 via the virtual ports 12025 and 12026 of the CEE switch 1200 and the virtual port 13072 of the storage apparatus 1300 by the virtual port 11072 and the zone 2 is set.

In the following, the operation of the storage system of the present embodiment is explained. Here, it is assumed that the service processors 1108, 1108a, 1207, 1308, and 1308a have acquired control information indicative of the state of each apparatus of the storage system in advance.

First the service processors 1108 and 1108a check the use situation of the storage regions of the storage apparatuses 1300 and 1300a in each of the servers 1100 and 1100a.

Here, when the margin of the storage region runs short in the server 1100, if the unallocated storage region that may be allocated does not exist or runs short, the service processor 1108 makes a request to the service processor (for example, service processor 1308) of the storage apparatus (for example, storage apparatus 1300) in which the amount of use of the storage region is 50% or less for disconnection of the empty storage region.

Upon receipt of the request for disconnection, the service processor 1308 disconnects 50% of the empty storage region from the server (for example, server 1100a) to which the storage region is allocated to produce an unallocated storage region and sets the virtual port 13072.

The service processor 1108 sets the virtual port 11072 to be connected to the unallocated storage region of the storage apparatus 1300 in a state capable of being used by the server 1100, and transmits control information having information of the set virtual port 11072 to the service processor 1207.

Upon receipt of the transmitted control information, the service processor 1207 sets the virtual ports 12025 and 12026, performs zoning of the virtual ports 11072, 12025, 12026, and 13072, and sets the zone 2.

Next, the service processor 1108 transmits instructions to recognize the storage region of the storage apparatus 1300 allocated to the server 1100 to the server 1100. Due to this, it is made possible for the server 1100 to use the allocated storage region.

As described above, in the server 1100 of the fifth embodiment, the unallocated storage region is allocated to the server 1100 by performing transmission and reception of control information with the CEE switch 1200, and the storage apparatuses 1300a and 1300 by the physical port 13071a or the virtual port 13072. Due to this, also when data and control signals share an electric or optical communication line, in the case where the storage capacity allocated to the server 1100 runs short, it is made possible to easily change arrangement of storage resources of each apparatus of the storage system without the need to newly provide a storage apparatus and without the need to stop the communication operation of each apparatus of the storage system.

Note that, it is possible to implement the processing function described above by a computer. In such a case, there are provided programs describing contents of processing of the function that the servers 100, 700, 900, and 1100 need to have. By a computer executing the programs, the processing function described above is implemented on the computer. It is possible to store programs describing contents of processing in a computer-readable storage medium. As a computer-readable storage medium, mention is made of a magnetic storage apparatus, an optical disc, a magneto-optical storage medium, a semiconductor memory, etc. The magnetic storage apparatus includes a hard disk drive, a flexible disc (FD), a magnetic tape, etc. The optical disc includes a DVD, a DVD-RAM, a CD-ROM/RW, etc. The magneto-optical storage medium includes an MO etc.

When programs are distributed, for example, a portable storage medium on which the programs are recorded, such as a DVD and a CD-ROM, is made available in the market. Further, it may also be possible to store the programs in a storage apparatus of a server computer and to transfer the programs from the server computer to another computer via a network.

A computer that executes programs stores the programs recorded, for example, on a portable storage medium or the programs transferred from a server computer in the storage apparatus thereof. Then, the computer reads the programs from the storage apparatus thereof and performs processing in accordance with the programs. Note that, it is also possible for a computer to read programs directly from a portable storage medium and to perform processing in accordance with the programs. Further, it is also possible for a computer to sequentially perform processing in accordance with a program that is received each time the program is transferred from a server computer connected via a network.

In addition, it is also possible to implement at least part of the processing function described above by an electronic circuit, such as a DSP (Digital Signal Processor), an ASIC (Application Specific Integrated Circuit), and a PLD (Programmable Logic Device).

According to the information processing apparatus, the switch, the storage system, the storage system control method, and the storage system control program disclosed herein, it is made possible to easily change arrangement of storage resources of a storage system.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. An information processing apparatus of a storage system in which a plurality of information processing apparatuses reads and writes data from and to storage regions of a plurality of storage apparatuses connected by a communication line via a switch, the information processing apparatus comprising:
a physical port configured to transmit and receive the data by communicating with the storage apparatus; and
a processor configured to perform a procedure including:
calculating, based on a storage capacity of a storage region of a storage apparatus allocated to the information processing apparatus and an amount of use of the storage region, a use rate of the storage region;
determining whether or not to perform allocation of a storage region based on the calculated use rate;
allocating, when determining to perform the allocation of a storage region, an unallocated storage region allocated to none of information processing apparatuses to the information processing apparatus, and also setting a virtual port and making connection with the unallocated storage region allocated to the information processing apparatus by the set virtual port; and
performing transmission and reception of data with a storage apparatus having the storage region allocated to the information processing apparatus by the physical port or the virtual port set at the physical port.

2. The information processing apparatus according to claim 1, wherein
the procedure further includes
determining whether or not to perform disconnection of a storage region based on the calculated use rate, and
disconnecting, when determining to perform the disconnection, part or whole of an empty region in the storage region allocated to the information processing apparatus so as to be allocated to another information processing apparatus to produce an unallocated storage region.

3. The information processing apparatus according to claim 1, wherein
the allocating includes making a request to disconnect part or whole of an empty region in a storage region allocated to another information processing apparatus to produce an unallocated storage region, and allocating the unallocated storage region to the information processing apparatus.

4. The information processing apparatus according to claim 1, wherein:
the allocating includes
making a request to said each storage apparatus for control information including information indicative of an amount of an unallocated storage region of said each storage apparatus,
determining a storage apparatus having a largest unallocated storage region based on the control information; and
allocating the unallocated storage region of the determined storage apparatus to the information processing apparatus.

5. The information processing apparatus according to claim 1, wherein
the making connection includes
making a request to a storage apparatus having an unallocated storage region to be allocated to the information processing apparatus for control information including information indicative of a virtual port set by the storage apparatus, and
connecting to the unallocated storage region allocated to the information processing apparatus by connecting the set virtual port and the virtual port of the storage apparatus based on the control information.

6. The information processing apparatus according to claim 1, wherein:
the information processing apparatus further includes a control port configured to transmit and receive control information; and
the allocating includes allocating the unallocated storage region to the information processing apparatus by performing transmission and reception of control information with a storage apparatus having the allocated unallocated storage region by the control port.

7. The information processing apparatus according to claim 1, wherein:
the processor is capable of operating a plurality of virtual machines;
each of the plurality of virtual machines performs transmission and reception of the data with a storage apparatus having a storage region allocated to said each virtual machine by the physical port or a virtual port set at the physical port;
the calculating includes calculating the use rate of the storage region based on a storage capacity of a storage region of a storage apparatus allocated to the virtual machine and an amount of use of the storage region;
the allocating includes allocating the virtual machine an unallocated storage region allocated to none of information processing apparatuses and none of the virtual machines;
the setting of the virtual port includes setting the virtual port for the virtual machine; and
the connecting includes connecting the virtual machine and the allocated unallocated storage region by the set virtual port.

8. The information processing apparatus according to claim 1, wherein:
the information processing apparatus further includes a control port configured to transmit and receive control information; and
the allocating includes allocating the unallocated storage region to the information processing apparatus under control of a management terminal apparatus by transmitting and receiving the control information by the control port, the management terminal apparatus being configured to perform control of allocation of a storage region.

9. The information processing apparatus according to claim 1, wherein
the allocating includes allocating the unallocated storage region to the information processing apparatus by transmitting and receiving control information by the physical port or the virtual port.

10. A switch configured to relay communication with a plurality of information processing apparatuses that reads and writes data from and to storage regions of a plurality of storage apparatuses connected by a communication line, the switch comprising:
a first physical port configured to transmit and receive the data by communicating with the information processing apparatus;
a second physical port configured to transmit and receive the data by communicating with the storage apparatus; and
a processor configured to perform a procedure including:
connecting, when a request is made from the information processing apparatus for connection of an unallocated storage region allocated to none of information processing apparatuses, the information processing apparatus having made the request and the unallocated storage region by a first virtual port set at the first physical port and a second virtual port set at the second physical port;
performing transmission and reception of data with a storage apparatus having a storage region allocated to the information processing apparatus by the first physical port or the first virtual port; and
performing transmission and reception of data with the storage apparatus by the second physical port or the second virtual port.

11. A storage system in which a plurality of information processing apparatuses reads and writes data from and to storage regions of a plurality of storage apparatuses connected by a communication line via a switch,
wherein the information processing apparatus is configured to:
calculate, based on a storage capacity of a storage region of a storage apparatus allocated to the information processing apparatus and an amount of use of the storage region, a use rate of the storage region;
determine whether or not to perform allocation of a storage region based on the calculated use rate;
make a request, when determining to perform the allocation of a storage region, to a storage apparatus having an unallocated storage region allocated to none of information processing apparatuses and the switch for allocation of the unallocated storage region; and
perform transmission and reception of data with a storage apparatus having a storage region allocated to the information processing apparatus by an information processing apparatus physical port configured to transmit and receive the data by communicating with the storage apparatus or an information processing apparatus virtual port set at the information processing apparatus physical port,
wherein the switch is configured to:
connect, when a request is made from the information processing apparatus for allocation of the unallocated storage region, the information processing apparatus having made the request and the unallocated storage region whose allocation has been requested by a first switch virtual port set at a first switch physical port connected to the information processing apparatus physical port by the communication line and a second switch virtual port set at a second switch physical port configured to transmit and receive the data by communicating with a storage apparatus having an unallocated storage region allocated to the information processing apparatus;
perform transmission and reception of data with the information processing apparatus by the first switch physical port or the first switch virtual port; and
perform transmission and reception of data with a storage apparatus having a storage region allocated to the information processing apparatus by the second switch physical port or the second switch virtual port; and
wherein the storage apparatus is configured to:
set, when a request is made from the information processing apparatus for allocation of the unallocated storage region, a storage apparatus virtual port at a storage apparatus physical port configured to transmit and receive the data by communicating with the information processing apparatus, and connect the unallocated storage region whose allocation has been requested and the information processing apparatus having made the request by the storage apparatus virtual port; and
perform transmission and reception of data with the information processing apparatus by the storage apparatus physical port or the storage apparatus virtual port.

12. A storage system control method for controlling a storage system in which a plurality of information processing apparatuses reads and writes data from and to storage regions of a plurality of storage apparatuses connected by a communication line via a switch, the method comprising:
calculating a use rate based on a storage capacity of a storage region of a storage apparatus allocated to the information processing apparatus and an amount of use of the storage region;
determining whether or not to perform allocation based on the calculated use rate;
allocating, when determining to perform the allocation, an unallocated storage region allocated to none of information processing apparatuses to the information processing apparatus, and also setting a virtual port set at a physical port configured to transmit and receive the data by communicating with the storage apparatus and connecting the information processing apparatus to the unallocated storage region allocated by the set virtual port; and
performing transmission and reception of data with a storage apparatus having a storage region allocated to the information processing apparatus by a physical port configured to transmit and receive the data by communicating with the storage apparatus or a virtual port set at the physical port.

13. A computer-readable storage medium storing a computer program to control a storage system in which a plurality of information processing apparatuses reads and writes data from and to storage regions of a plurality of storage apparatuses connected by a communication line via a switch, the computer program causing a computer to perform a procedure comprising:
calculating a use rate based on a storage capacity of a storage region of a storage apparatus allocated to the information processing apparatus and an amount of use of the storage region;
determining whether or not to perform allocation based on the calculated use rate;
allocating, when determining to perform the allocation, an unallocated storage region allocated to none of information processing apparatuses to the information processing apparatus, and also setting a virtual port set at a physical port configured to transmit and receive the data by communicating with the storage apparatus and connecting the information processing apparatus to the unallocated storage region allocated by the set virtual port; and
performing transmission and reception of data with a storage apparatus having a storage region allocated to the information processing apparatus by a physical port configured to transmit and receive the data by communicating with the storage apparatus or a virtual port set at the physical port.
